(19) United States
(12) Patent Application Publication
(10) Pub. No.: US 2006/0225827 A1
(43) Pub. Date: Oct. 12, 2006

(54) Process for forming polarizer plate

(76) Inventors: Herong Lei, Webster, NY (US); Brian S. Rice, Fairport, NY (US); Robert L. Walton, Fairport, NY (US); Kelly S. Robinson, Fairport, NY (US); Robert C. Updike, Rochester, NY (US)

Correspondence Address: Paul A. Leipold;Patent Legal Staff, Eastman Kodak Company, 343 State Street, Rochester, NY, 14650-2201, US

(21) Appl. No.: 11/102,393

(22) Filed: Apr. 8, 2005

(51) Int. Cl. B32B 37/00; B32B 37/06; B32B 37/12; B32B 38/00; B32B 38/18; B32B 38/10; B32B 37/20

(52) U.S. Cl. 156/64; 156/247; 156/249; 156/322; 156/184; 156/229

(57) ABSTRACT

The present invention generally relates to polymer films and a process for forming a polarizer plate comprising supplying cover sheets on carrier webs, peeling the cover sheet from the carrier webs, spreading the cover sheets, and laminating the cover sheets to a polarizing film. The process may further comprise means for improved tension control, static dissipation after peeling the cover sheet from the carrier web, and an accumulator after a double splicing operation for splicing expiring web to fresh web.

### FIELD OF THE INVENTION

The present invention generally relates to a process for making a polarizer plate. In particular, the process comprises supplying a protective cover sheet on a carrier web and then peeling the cover sheet from the carrier web before laminating the cover sheet to a polarizing film. The process further comprises improved tension control after peeling the cover sheet from the carrier web.

### BACKGROUND OF THE INVENTION

Transparent “resin films” are used in a variety of optical applications. For example, resin films are used in protective cover sheets for light polarizers in a variety of electronic displays, including Liquid Crystal Displays (LCD).

The structure of LCDs may include a liquid crystal cell, one or more polarizer plates, and one or more light management films. Liquid crystal cells are formed by confining liquid crystals such as vertically-aligned (VA), in-plane switching (IPS), twisted nematic (TN) or super twisted nematic (STN) materials between two electrode substrates. Polarizer plates are typically a multi-layer element comprising resin films. In particular, a polarizer plate can comprise a polarizing film sandwiched between two protective cover sheets. Polarizing films are normally prepared from a transparent and highly uniform, amorphous resin film that is subsequently stretched to orient the polymer molecules and then stained with a dye to produce a dichroic film. An example of a suitable resin for the formation of polarizer films is fully hydrolyzed polyvinyl alcohol (PVA). Because the stretched PVA films used to form polarizers are very fragile and dimensionally unstable, protective cover sheets are normally laminated to both sides of the polarizing film to offer both support and abrasion resistance.

Protective cover sheets of polarizer plates are required to have high uniformity, good dimensional and chemical stability, and high transparency. Originally, protective coversheets were formed from glass, but a number of resin films are now used to produce lightweight and flexible polarizers. Many resins have been suggested for use in protective cover sheets including cellulosics, acrylics, cyclic olefin polymers, polycarbonates, and sulfones. However, acetyl cellulose polymers are most commonly used in protective cover sheets for polarizer plates. Polymers of the acetyl cellulose type are commercially available in a variety of molecular weights as well as the degree of acyl substitution of the hydroxyl groups on the cellulose backbone. Of these, the fully substituted polymer, triacetyl cellulose (TAC) is commonly used to manufacture resin films for use in protective cover sheets for polarizer plates.

The cover sheet normally requires a surface treatment to insure good adhesion to the PVA-dichroic film. When TAC is used as the protective cover film of a polarizer plate, the TAC film is subjected to treatment in an alkali bath to saponify the TAC surface to provide suitable adhesion to the PVA dichroic film. The alkali treatment uses an aqueous solution containing a hydroxide of an alkali metal, such as sodium hydroxide or potassium hydroxide. After alkali treatment, the cellulose acetate film is typically washed with weak acid solution followed by rinsing with water and drying. This saponification process is both messy and time consuming.

U.S. Pat. No. 2,362,580 describes a laminar structure wherein two cellulose ester films each having a surface layer containing cellulose nitrate and a modified PVA is adhered to both sides of a PVA film. JP 06094915A discloses a protective film for polarizer plates wherein the protective film has a hydrophilic layer which provides adhesion to PVA film. Commonly-assigned, copending U.S. patent application Ser. No. 11/028,036 describes a guarded protective cover sheet having a removable, carrier substrate and a cover sheet comprising a low birefringence protective polymer film and a layer promoting adhesion to polyvinyl alcohol on the same side of the carrier substrate as the low birefringence protective polymer film which eliminates the need for the saponification process.

Protective cover sheets may be a composite or multilayer film including other functional layers (herein also referred to as auxiliary layers) such as an antiglare layer, antireflection layer, anti-smudge layer, compensation layer, or antistatic layer. Generally, these functional layers are applied in a process step that is separate from the manufacture of the low-birefringence protective polymer film, but may be later applied to a polarizing film as a composite film. An auxiliary film may combine functions of more than one functional layer or a protective polymer film may also serve the function of an auxiliary layer.

For example, some LCD devices may contain a protective cover sheet that also serves as a compensation film to improve the viewing angle of an image. Compensation films (i.e. retardation films or phase difference films) are normally prepared from amorphous films that have a controlled level of birefringence prepared, for example, either by uniaxial stretching or by coating with discotic dyes. Suitable resins suggested for formation of compensation films by stretching include polyvinyl alcohols, polycarbonates and sulfones. Compensation films prepared by treatment with dyes normally require highly transparent films having low birefringence such as TAC and cyclic olefin polymers.

In general, resin films as described above are prepared either by melt extrusion methods or by casting methods. Melt extrusion methods involve heating the resin until molten (approximate viscosity on the order of 100,000 cp), then applying the hot molten polymer to a highly polished metal band or drum with an extrusion die, cooling the film, and finally peeling the film from the metal support. For several reasons, however, films prepared by melt extrusion are generally not suitable for optical applications. Principal among these is the fact that melt extruded films exhibit a high degree of optical birefringence. In the case of highly substituted cellulose acetate, there is the additional problem of melting the polymer. Cellulose triacetate has a very high melting temperature of 270-300° C., and this is above the temperature where decomposition begins. Films have been formed by melt extrusion at lower temperatures by compounding cellulose acetate with various plasticizers as taught in U.S. Pat. No. 5,219,510 to Machell. However, the polymers described in U.S. Pat. No. 5,219,510 to Machell are not the fully substituted cellulose triacetate, but rather have a lesser degree of alkyl substitution or have propionate groups in place of some acetate groups. Even so, melt extruded films of cellulose acetate are known to exhibit poor flatness as noted in U.S. Pat. No. 5,753,140 to Shigenmura. For these reasons, melt extrusion methods are generally not practical for fabricating many resin films including cellulose triacetate films used to prepare protective covers and substrates in electronic displays. Rather, casting methods are generally preferred to manufacture these films.

Resin films for optical applications are manufactured almost exclusively by casting methods. Casting methods involve first dissolving the polymer in an appropriate solvent to form a dope having a high viscosity on the order of 50,000 cp, and then applying the viscous dope to a continuous highly polished metal band or drum through an extrusion die, partially drying the wet film, peeling the partially dried film from the metal support, and conveying the partially dried film through an oven to more completely remove solvent from the film. Cast films typically have a final dry thickness in the range of 40-200 microns. In general, thin films of less than 40 microns are very difficult to produce by casting methods due to the fragility of wet film during the peeling and drying processes. Films having a thickness of greater than 200 microns are also problematic to manufacture due to difficulties associated with the removal of solvent in the final drying step. Although the dissolution and drying steps of the casting method add complexity and expense, cast films generally have better optical properties when compared to films prepared by melt extrusion methods and, moreover, problems related to decomposition associated with exposure to high temperature are avoided.

Examples of optical films prepared by casting methods include: 1) Cellulose acetate sheets used to prepare light polarizing films as disclosed in U.S. Pat. No. 4,895,769 to Land and U.S. Pat. No. 5,925,289 to Cael as well as more recent disclosures in U.S. Patent Application. 2001/0039319 A1 to Harita and U.S. Patent Application 2002/001700 A1 to Sanefuji; 2) Cellulose triacetate sheets used for protective covers for light polarizing films as disclosed in U.S. Pat. No. 5,695,694 to Iwata; 3) Polycarbonate sheets used for protective covers for light polarizing films or for retardation plates as disclosed in U.S. Pat. No. 5,818,559 to Yoshida and U.S. Pat. Nos. 5,478,518 and 5,561,180 both to Taketani; and (4) Polyethersulfone sheets used for protective covers for light polarizing films or for retardation plates as disclosed in U.S. Pat. Nos. 5,759,449 and 5,958,305 both to Shiro.

Commonly-assigned U.S. Patent Application Publications 2003/0215658A, 2003/0215621A, 2003/0215608A, 2003/0215583A, 2003/0215582A, 2003/0215581A, and 2003/0214715A describe a coating method to prepare resin films having low birefringence that are suitable for optical applications. The resin films are applied onto a discontinuous, removable carrier substrate from lower viscosity polymer solutions than are normally used to prepare cast films. The dried film/substrate composite is wound into rolls. U.S. 2003/0215608 A1 to Bermel states that a minimum level of adhesion between the film at the carrier substrate is needed to avoid blister defects in a multi-pass film. However, excessive adhesion is undesirable since during subsequent peeling operations the film may be damaged.

For optical films, good dimensional stability is necessary during storage as well as during subsequent fabrication of polarizer plates. In addition, resin films used in protective cover sheets for polarizer plates are susceptible to scratch and abrasion, as well as the accumulation of dirt and dust, during the manufacture and handling of the cover sheet.

The preparation of high quality polarizer plates for display applications requires that the protective cover sheet be free of defects due to physical damage or the deposition of dirt and dust. It would be very advantageous to avoid the need for saponification of cover sheets in which the preparation of polarizer plates from resin films requires a lamination process involving pretreatment in an alkali bath and then application of adhesives, pressure, and high temperatures. Avoiding such a saponification would improve both productivity and reduce the necessary conveyance and handling of the sheets. Although advantageous for cover sheets in general, this would be especially desirable for thinner cover sheets.

The preparation of very high quality polarizer plates would require avoiding the various problems and defects known in the prior art, which would tend to be exacerbated when employing thinner protective cover sheets. Such problems and defects include moving separation line, chatterlines, drawlines, sticky spots, creases, and web breaks.

### SUMMARY OF THE INVENTION

The present invention relates generally to a method of making a polarizer plate involving peeling of a protective cover sheet from a carrier web prior to lamination to a polarizing film. Peeling a top layer from a multi-layer potentially involves various defects and problems, including those defects and problems derived from electrostatic charge generated by the peeling and tension variation caused, for example, from the pull of the peeled cover sheet into the winder for the carrier web.

It is an object to provide an improved process for the fabrication of polarizer plates.

It is a further object of the present invention to overcome the limitations of prior-art manufacture of polarizer plates and to provide an improved method that eliminates the need for complex surface treatments such as saponification prior to the fabrication of polarizer plates.

It is another object to provide an improved process in which the protective cover sheet is less susceptible to physical damage such as scratch and abrasion during the handling and processing steps necessary in the fabrication of polarizer plates.

These and other objects of the invention are accomplished by a method in which the protective cover sheet for polarizers comprises a low birefringence protective polymer film and a layer promoting adhesion to polyvinyl alcohol films comprising a hydrophilic polymer, which cover sheet is supplied on a carrier web.

The process provides excellent adhesion of a protective cover sheet to the polyvinyl alcohol-containing dichroic polarizing films and eliminates the need to alkali treat the cover sheets prior to lamination to the dichroic films, thereby simplifying the process for manufacturing polarizer plates.

Optionally, auxiliary layers that include an abrasion-resistant layer, antiglare layer, low reflection layer, antireflection layer, antistatic layer, viewing angle compensation layer, and moisture barrier layer may be employed in the cover sheets used in the process of the invention.

In particular, the present process comprises supplying at least one, preferably two, cover sheets on carrier webs, peeling the cover sheets from the carrier web, and laminating the cover sheet to the PVA-dichroic film. The term “sheet” as used here, unless otherwise indicated, can refer to a web that is unwound from or wound on a roll or the like. The process may further comprise means for improved tension control, static dissipation after peeling the cover sheet from the carrier web, and an accumulator before or after the peeling step to allow continuous operation. The composite comprising the cover sheet and carrier substrate are preferably wound into rolls and stored until needed for the fabrication of polarizer plates.

More particularly, the present invention relates to a method of forming a polarizing plate comprising providing at least one guarded cover sheet composite comprising a carrier substrate and a cover sheet comprising a layer promoting adhesion to polyvinyl alcohol and a low birefringence polymer film, providing a dichroic film, and bringing said cover sheet into contact with said dichroic film such that the layer promoting adhesion to polyvinyl alcohol in said cover sheet is in contact with said dichroic film thereby producing a composite polarizer sheet comprising a protective cover sheet and a dichroic film adhesively joined by the adhesive layer, wherein said carrier substrate is peeled from the cover sheet prior to bringing the cover sheet into contact with the dichroic film, and wherein the method further comprising controlling the tension of at least the cover sheet following peeling of the carrier substrate therefrom.

In one preferred embodiment of the present invention, a method of forming a polarizer plate comprises the following steps:

(a) supplying a first and second web (second web optional) from a first and second unwinding spindle, respectively, each of said first and second webs comprising a guarded cover sheet having a carrier substrate and a protective cover sheet (plus optional auxiliary layers), the protective cover sheet comprising a low birefringence polymer protective film and a layer promoting adhesion to polyvinyl alcohol films;

(b) conveying each web in proximity to a means for double-sided splicing, wherein when each of said first or second webs is near to expiring, which can occur independently, each web is secured to said means for double splicing and then each such expiring web is double spliced, preferably butt sliced, with a fresh web such that peeling and laminating steps to follow are maintained in continuous operation;

(c) optionally conveying each web through an accumulator positioned between a first and second means for isolating tension in the accumulator during splicing;

(d) conveying each web through the second means for isolating tension which may be a drive;

(e) for each web, removing said carrier substrate from said protective cover sheet at a peeling station, to produce at the point (in cross-section) of peeling, respectively, (i) a first and second unguarded web, each comprising the protective cover sheet, and (ii) a first and second carrier web each comprising the carrier substrate;

(f) conveying each unguarded web over means for controlling tension, for example, a load cell roller or float roller, having feedback control to a means for isolating tension (or a drive which may be the unwinding spindle or unwinder) located before the peeling station;

(g) preferably conveying each unguarded web over a means for spreading the web;

(h) bringing each unguarded web, either simultaneously or sequentially, into contact with a polarizing web comprising a dichroic PVA film such that each layer promoting adhesion to polyvinyl alcohol, in each of said two unguarded webs, are contacted with said dichroic PVA film, wherein pressure is applied as said PVA dichroic film and cover sheets are brought into contact, thereby forming a polarizer plate web; and

(i) drying the polarizer plate web.

The present process is capable of providing high quality lamination and, at the same time, can be performed continuously at relatively elevated speeds, such that a robust and economic manufacture of high quality polarizing plates is obtained.

### BRIEF DESCRIPTION OF THE DRAWINGS

FIG. 1 is a schematic of an exemplary coating and drying apparatus that can be used in the practice of the method of the present invention;

FIG. 2 is a schematic of an exemplary coating and drying apparatus as in FIG. 1 but also including a station where an alternate winding operation further comprises application of a strippable protection layer;

FIG. 3 is a schematic of an exemplary multi-slot coating apparatus that can be used in the practice of the present invention;

FIG. 4 is a schematic of one embodiment of the present process comprising web peeling, conveyance, and lamination, without employing accumulators at the carrier web winders;

FIG. 5 is a schematic of another embodiment of the present process comprising web peeling, conveyance, and lamination, differing from the embodiment of FIG. 4 by further comprising the use of accumulators at the carrier web winders;

FIG. 6 is a schematic of another embodiment of the present process comprising web peeling, conveyance, and lamination, differing from the embodiment of FIG. 4 by employing a sequential lamination of the protective cover sheet to the polarizing film;

FIG. 7 is a schematic of another embodiment of the present process comprising web peeling, conveyance, and lamination, differing from the embodiment of FIG. 4 by not employing accumulators after the unwinding spindles for the supply rolls, and instead employing an accumulator after the lamination station;

FIG. 8 is a schematic of yet another embodiment of the present process comprising web peeling, conveyance, and lamination in a batch process;

FIG. 9 is a schematic of one embodiment of a double layer butt splice that may be used in practicing the present invention;

FIGS. 10a, 10b are schematic embodiments of a double-layer overlap splice that may be used in practicing the present invention;

FIG. 11 is a schematic of an embodiment of a peeling station comprising film peeling with a nip roller that can be used instead of a single roller shown in previous FIGS. 4 to 7;

FIGS. 12a, 12b are schematics of yet another embodiment of a peeling station comprising a knife edge that can be used instead of the peeling stations shown in previous figures;

FIG. 13 is a schematic of a logic diagram for accomplishing improved tension control following the peeling point (in cross-section);

FIG. 14 shows a cross-sectional representation of a three-layer cover sheet that can be used in the invention;

FIG. 15 shows a cross-sectional representation of a guarded cover sheet, which can be used in the invention, comprising a three-layer cover sheet and a partially peeled carrier substrate;

FIG. 16 shows a cross-sectional representation of a guarded cover sheet, which can be used in the invention, comprising a four-layer cover sheet and a partially peeled carrier substrate;

FIG. 17 shows a cross-sectional representation of a guarded cover sheet, which can be used in the invention, comprising a four-layer cover sheet and a partially peeled carrier substrate wherein the carrier substrate has a release layer formed thereon; and

FIG. 18 shows a cross-sectional representation of a liquid crystal cell with polarizer plates, which can be made in accordance with the present invention, on either side of the cell;

### DETAILED DESCRIPTION OF THE INVENTION

The following definitions apply to the description herein:

In-plane phase retardation Rᵢₙ, of a layer is a quantity defined by (nx−ny)d, where nx and ny are indices of refraction in the direction of x and y; x is taken as the direction of maximum index of refraction in the x-y plane and y direction is taken perpendicular to it; the x-y plane is parallel to the surface plane of the layer; and d is a thickness of the layer in the z-direction. The quantity (nx−ny) is referred to as in-plane birefringence, Δnᵢₙ. The value of Δnᵢₙ is given at a wavelength λ=550 nm.

Out of-plane phase retardation Rₜₕ, of a layer is a quantity defined by [nz−(nx+ny)/2]d, where nz is the index of refraction in the z-direction. The quantity [nz−(nx+ny)/2] is referred to as out-of-plane birefringence, Δnₜₕ. If nz>(nx+ny)/2, Δnₜₕ is positive (positive birefringence), and thus the corresponding Rₜₕ is also positive. If nz<(nx+ny)/2, Δnₜₕ is negative (negative birefringence) and Rₜₕ is also negative. The value of Δnₜₕ is given at λ=550 nm.

Intrinsic Birefringence Δnᵢₙₜ, of a polymer refers to the quantity defined by (ne−no), where ne and no are the extraordinary and the ordinary index of the polymer, respectively. The actual birefringence (in-plane Δnᵢₙ or out-of-plane Δnₜₕ) of a polymer layer depends on the process of forming it, thus the parameter Δnᵢₙₜ.

Amorphous is defined as a lack of long-range order. Thus, an amorphous polymer does not show long-range order as measured by techniques such as X-ray diffraction.

Transmission is a quantity to measure the optical transmissivity. It is given by the percentile ratio of out coming light intensity Iₒᵤₜ to input light intensity Iᵢₙ as Iₒᵤₜ/Iᵢₙ×100.

Optic Axis refers to the direction in which propagating light does not see birefringence.

Uniaxial is defined as two of the three indices of refraction, nx, ny, and nz, are essentially the same.

Biaxial is defined as that the three indices of refraction, nx, ny, and nz, are all different.

Acid number for a polymer is defined as the number of milligrams of KOH required to neutralize 1 gram of polymer solids.

Cover sheets employed in Liquid Crystal Displays are typically polymeric sheets having low optical birefringence that are employed on each side of a dichroic PVA film in order to maintain the dimensional stability of the dichroic PVA film and to protect it from moisture and UV degradation. In the following description a guarded cover sheet is defined as a cover sheet that is disposed on a removable, protective carrier substrate. A strippable, protective film may also be employed on the side of the cover sheet opposite to the carrier substrate so that both sides of the cover sheet are protected prior to its use in a polarizer plate.

A layer promoting adhesion to PVA is a distinct layer that is applied in a coating step either separate from or simultaneous with the application of the low birefringence protective polymer film. The layer promoting adhesion to PVA provides acceptable adhesion of the cover sheet to a dichroic PVA film (in a liquid crystal display application) without the need for a wet pretreatment, such as saponification, of the cover sheet prior to lamination to the PVA film.

An optional tie layer is a distinct layer that is applied in a coating step either separate from or simultaneous with the application of the low birefringence protective polymer film or layer promoting adhesion to PVA.

The present invention relates to an improved method of using the protective cover sheet to fabricate polarizers (polarizers are also referred to as polarizing plates or polarizer plates). The protective cover sheet used in the invention comprises a low birefringence protective polymer film and a layer promoting adhesion to polyvinyl alcohol films, preferably comprising a hydrophilic polymer. In other embodiments, the protective cover sheet can optionally further comprise a tie layer or one or more auxiliary layers. Suitable auxiliary layers for use in the present invention include an abrasion resistant hardcoat layer, antiglare layer, anti-smudge layer or stain-resistant layer, antireflection layer, low reflection layer, antistatic layer, viewing angle compensation layer, and moisture barrier layer.

The protective cover sheet used in the present process is provided as a guarded cover sheet composite comprising a carrier substrate and the protective cover sheet. Optionally, the guarded cover sheet composite of the invention also comprises a strippable, protection layer on the side of the cover sheet opposite to the carrier substrate. The guarded cover sheet composite is particularly advantageous and effective when the low birefringence protective polymer film is thin, for example, when the thickness is about 40 micrometers or less, preferably about 20 to 30 micrometers.

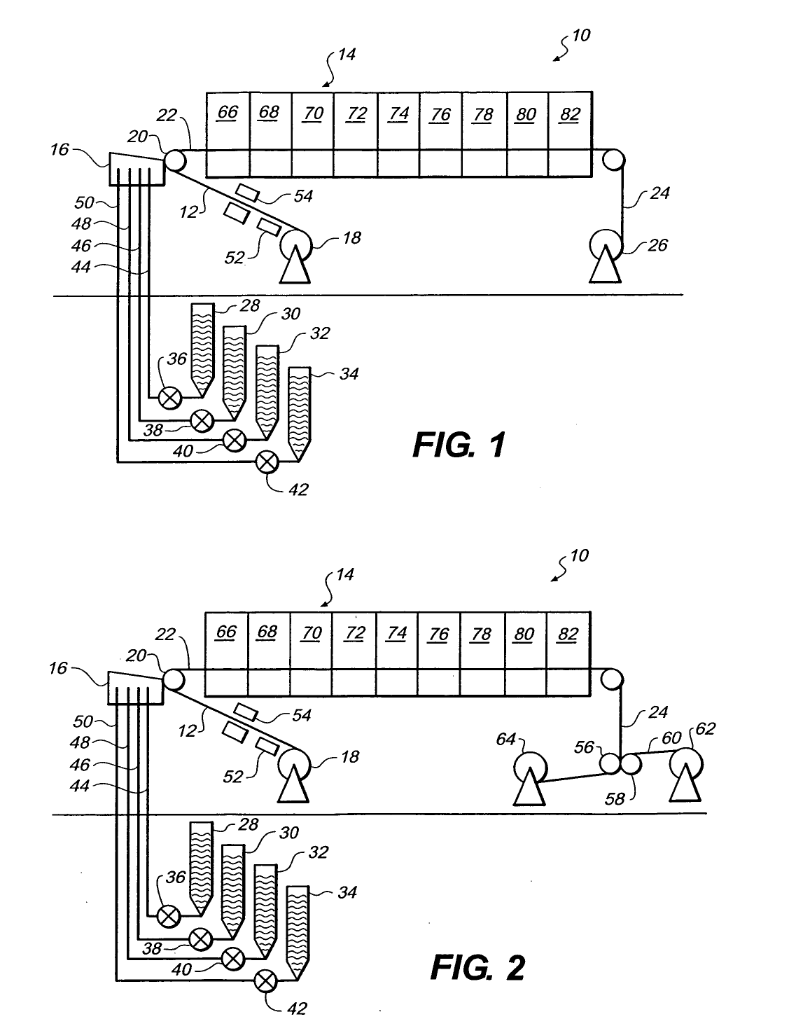

Turning now to FIG. 1 there is shown a schematic of an exemplary and well-known coating and drying system 10 suitable for preparing the cover sheets used in the present invention. The coating and drying system 10 may be used to apply very thin films to a moving carrier substrate 12 and to subsequently remove solvent in a dryer 14. A single coating apparatus 16 is shown such that coating and drying system 10 has only one coating application point and only one dryer 14, but two or three (even as many as six) additional coating application points with corresponding drying sections are known in the fabrication of composite thin films. The process of sequential application and drying is known in the art as a tandem coating operation.

Coating and drying system 10 includes an unwinding station 18 to feed the moving substrate 12 around a back-up roller 20 where the coating is applied by coating apparatus 16. The coated substrate 22 then proceeds through the dryer 14. In one embodiment of the present invention, the guarded cover sheet composite 24 comprising a cover sheet on substrate 12 is wound into rolls at a wind-up station 26.

As depicted, an exemplary four-layer coating is applied to moving substrate 12. Coating liquid for each layer is held in respective coating supply vessel 28, 30, 32, 34. The coating liquid is delivered by pumps 36, 38, 40, 42 from the coating supply vessels to the coating apparatus 16 via conduits 44, 46, 48, 50, respectively. In addition, coating and drying system 10 may also include electrical discharge devices, such as corona or glow discharge device 52, or polar charge assist device 54, to modify the moving substrate 12 prior to application of the coating.

Turning next to FIG. 2 there is shown a schematic of the same exemplary coating and drying system 10 depicted in FIG. 1 with an alternative winding operation to apply a strippable protection layer. Accordingly, the figures are numbered identically up to the winding operation. In the practice of the present invention the guarded cover sheet composite 24 comprising a carrier substrate (which may be a resin film, paper, resin-coated paper, or metal) with a cover sheet applied thereto is taken between opposing nip rollers 56, 58. The guarded cover sheet composite 24 is adhesively adhered or electrostatically adhered to a preformed strippable protection layer 60 which is supplied from unwinding station 62 and the guarded cover sheet composite containing the strippable protection layer is wound into rolls at wind-up station 64. Preferably, polyolefin or polyethylene phthalate (PET) is used as the preformed, strippable protection layer 60. Either the guarded cover sheet composite 24 or the preformed strippable protection layer 60 may be pretreated with an electric charge generator to enhance the electrostatic attraction of the preformed strippable protection layer 60 to the guarded cover sheet composite 24.

The coating apparatus 16 used to deliver coating fluids to the moving substrate 12 may be a multi-layer applicator such as a slide bead hopper, as taught for example in U.S. Pat. No. 2,761,791 to Russell, or a slide curtain hopper, as taught by U.S. Pat. No. 3,508,947 to Hughes. Alternatively, the coating apparatus 16 may be a single layer applicator, such as slot die bead hopper or jet hopper.

As mentioned above (FIGS. 1 and 2), coating and drying system 10 includes a dryer 14 that will typically be a drying oven to remove solvent from the coated film. An exemplary dryer 14 includes a first drying section 66 followed by eight additional drying sections 68-82 capable of independent control of temperature and air flow. Although dryer 14 is shown as having nine independent drying sections, drying ovens with fewer compartments are well known and may be used to practice the method of the present invention. The dryer 14 can have two or more independent drying zones or sections.

Preferably, each of drying sections 66-82 each has independent temperature and airflow controls. In each section, temperature may be adjusted between 5° C. and 150° C. To minimize drying defects from case hardening or skinning-over of the wet layers, optimum drying rates are needed in the early sections of dryer 14. There are a number of artifacts created when temperatures in the early drying zones are inappropriate. For example, fogging or blush of cellulose acetate films is observed when the temperature in zones 66, 68 and 70 are set at 25° C. This blush defect is particularly problematic when high vapor pressures solvents (methylene chloride and acetone) are used in the coating fluids. Aggressively high temperatures of 95° C. in the early drying sections 66, 68, and 70 tend to cause premature delamination of the cover sheet from the carrier substrate. Higher temperatures in the early drying sections are also associated with other artifacts such as case hardening, reticulation patterns and blistering of the cover sheet.

In a preferred embodiment, the first drying section 66 is operated at a temperature of at least about 25° C. but less than 95° C. with no direct air impingement on the wet coating of the coated web 22. In another preferred embodiment, drying sections 68 and 70 are also operated at a temperature of at least about 25° C. but less than 95° C. It is preferred that initial drying sections 66, 68 be operated at temperatures between about 30° C. and about 60° C. It is most preferred that initial drying sections 66, 68 be operated at temperatures between about 30° C. and about 50° C. The actual drying temperature in drying sections 66, 68 may optimize empirically within these ranges by those skilled in the art.

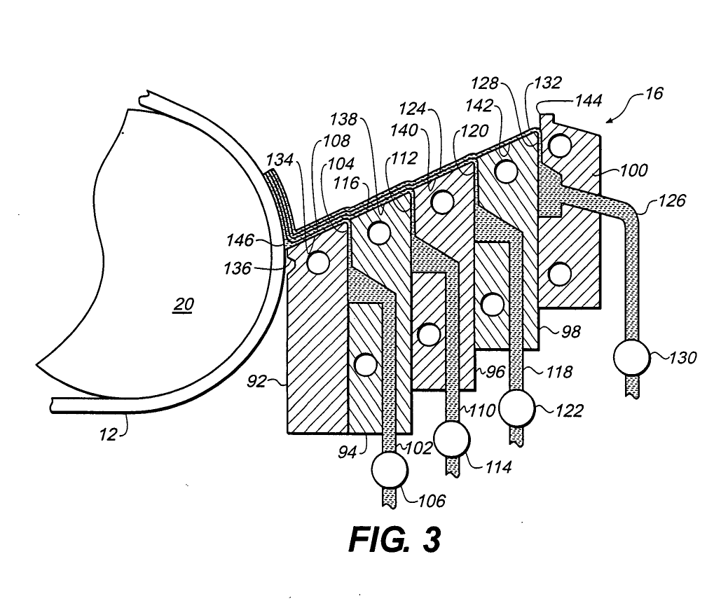

Referring now to FIG. 3, a schematic of an exemplary coating apparatus 16 is shown in detail. Coating apparatus 16, schematically shown in side elevational cross-section, includes a front section 92, a second section 94, a third section 96, a fourth section 98, and a back plate 100. There is an inlet 102 into second section 94 for supplying coating liquid to first metering slot 104 via pump 106 to thereby form a lowermost layer 108. There is an inlet 110 into third section 96 for supplying coating liquid to second metering slot 112 via pump 114 to form layer 116. There is an inlet 118 into fourth section 98 for supplying coating liquid to metering slot 120 via pump 122 to form layer 124. There is an inlet 126 into back plate 100 for supplying coating liquid to metering slot 128 via pump 130 to form layer 132. Each slot 104, 112, 120, 128 includes a transverse distribution cavity. Front section 92 includes an inclined slide surface 134, and a coating lip 136. There is a second inclined slide surface 138 at the top of second section 94. There is a third inclined slide surface 140 at the top of third section 96. There is a fourth inclined slide surface 142 at the top of fourth section 98. Back plate 100 extends above inclined slide surface 142 to form a back land surface 144. Residing adjacent the coating apparatus or hopper 16 is a coating back-up roller 20 about which a substrate 12 is conveyed. Coating layers 108, 116, 124, 132 form a multi-layer composite sheet that forms a coating bead 146 between coating lip 136 and substrate 12. Typically, the coating apparatus 16 is movable from a non-coating position toward the coating back-up roller 20 and into a coating position. Although coating apparatus 16 is shown as having four metering slots, coating dies having a larger number of metering slots (as many as nine or more) are well known and may be used to practice the method of the present invention.

The coating fluids for the low birefringence protective polymer film are comprised principally of a polymer binder dissolved in an organic solvent. In a particularly preferred embodiment, the low birefringence protective polymer film is a cellulose ester. These are commercially available in a variety of molecular weight sizes as well as in the type and degree of alkyl substitution of the hydroxyl groups on the cellulose backbone. Examples of cellulose esters include those having acetyl, propionyl and butyryl groups. Of particular interest is the family of cellulose esters with acetyl substitution known as cellulose acetate. Of these, the fully acetyl substituted cellulose having a combined acetic acid content of approximately 58.0-62.5% is known as triacetyl cellulose (TAC) and is generally preferred for preparing cover sheets used in electronic displays.

In terms of organic solvents for TAC, suitable solvents, for example, include chlorinated solvents (methylene chloride and 1,2 dichloroethane), alcohols (methanol, ethanol, n-propanol, isopropanol, n-butanol, isobutanol, diacetone alcohol and cyclohexanol), ketones (acetone, methylethyl ketone, methylisobutyl ketone, and cyclohexanone), esters (methyl acetate, ethyl acetate, n-propyl acetate, isopropyl acetate, isobutyl acetate, n-butyl acetate, and methylacetoacetate), aromatics (toluene and xylenes) and ethers (1,3-dioxolane, 1,2-dioxolane, 1,3-dioxane, 1,4-dioxane, and 1,5-dioxane). In some applications, small amounts of water may be used. Normally, TAC solutions are prepared with a blend of one or more of the aforementioned solvents. Preferred primary solvents include methylene chloride, acetone, methyl acetate, and 1,3-dioxolane. Preferred co-solvents for use with the primary solvents include methanol, ethanol, n-butanol and water.

Coating formulations may also contain plasticizers. Appropriate plasticizers for TAC films include phthalate esters (dimethylphthalate, dimethoxyethyl phthalate, diethylphthalate, dibutylphthalate, dioctylphthalate, didecylphthalate and butyl octylphthalate), adipate esters (dioctyl adipate), phosphate esters (tricresyl phosphate, biphenylyl diphenyl phosphate, cresyl diphenyl phosphate, octyl diphenyl phosphate, tributyl phosphate, and triphenyl phosphate), and glycolic acid esters (triacetin, tributyrin, butyl phthalyl butyl glycolate, ethyl phthalyl ethyl glycolate, and methyl phthalyl ethyl glycolate). Non-aromatic ester plasticizers as described in commonly assigned co-pending U.S. patent application Ser. No. 10/945,305. Plasticizers are normally used to improve the physical and mechanical properties of the final film. In particular, plasticizers are known to improve the flexibility and dimensional stability of cellulose acetate films. However, plasticizers are also used as coating aids in the converting operation to minimize premature film solidification at the coating hopper and to improve drying characteristics of the wet film. Plasticizers are used to minimize blistering, curl and delamination of TAC films during the drying operation. In a preferred embodiment of the present invention, plasticizers are added to the coating fluid at a total concentration of up to 50% by weight relative to the concentration of polymer in order to mitigate defects in the final TAC film.

The coating formulation for the low birefringence protective polymer may also contain one or more UV absorbing compounds to provide UV filter element performance and/or act as UV stabilizers for the low birefringence protective polymer film. Ultraviolet absorbing compounds are generally contained in the polymer in an amount of 0.01 to 20 weight parts based on 100 weight parts of the polymer containing no ultraviolet absorber, and preferably contained in an amount of 0.01 to 10 weight parts, especially in an amount of 0.05 to 2 weight parts. Any of the various ultraviolet light absorbing compounds which have been described for use in various polymeric elements may be employed in the polymeric elements of the invention, such as hydroxyphenyl-s-triazine, hydroxyphenylbenzotriazole, formamidine, or benzophenone compounds. As described in commonly assigned U.S. Pat. No. 6,872,766, the use of dibenzoylmethane ultraviolet absorbing compounds in combination with a second UV absorbing compound such as those listed above have been found to be particularly advantageous with respect to providing both a sharp cut off in absorption between the UV and visible light spectral regions as well as increased protection across more of the UV spectrum. Additional possible UV absorbers which may be employed include salicylate compounds such as 4-t-butylphenylsalicylate; and [2,2′-thiobis-(4-t-octylphenolate)]n-butylamine nickel(II). Most preferred are combinations of dibenzoylmethane compounds with hydroxyphenyl-s-triazine or hydroxyphenylbenzotriazole compounds.

Coating formulations may also contain surfactants as coating aids to control artifacts related to flow after coating. Artifacts created by flow after coating phenomena include mottle, repellencies, orange-peel (Bernard cells), and edge-withdraw. Surfactants used control flow after coating artifacts include siloxane and fluorochemical compounds. Examples of commercially available surfactants of the siloxane type include: (1) Polydimethylsiloxanes such as DC200 FLUID from Dow Corning; (2) Poly(dimethyl, methylphenyl)siloxanes such as DC510 FLUID from Dow Corning; (3) Polyalkyl substituted polydimethysiloxanes such as DC190 and DC1248 from Dow Corning as well as the L7000 SILWET series (L7000, L7001, L7004 and L7230) from Union Carbide; and (4) Polyalkyl substituted poly(dimethyl, methylphenyl)siloxanes such as SF1023 from General Electric. Examples of commercially available fluorochemical surfactants include: (1) Fluorinated alkyl esters such as the FLUORAD series (FC430 and FC431) from the 3M Corporation; (2) Fluorinated polyoxyethylene ethers such as the ZONYL series (FSN, FSN100, FSO, FSO100) from DuPont; (3) Polyperfluoroalkyl ethylacrylates such as the F series (F270 and F600) from NOF Corporation; and (4) Perfluoroalkyl derivatives such as the SURFLON series (S383, S393, and S8405) from the Asahi Glass Company. Surfactants are preferably of the non-ionic type, and either the siloxane or fluorinated type can be added to the uppermost layers.

In terms of surfactant distribution, surfactants are most effective when present in the uppermost layers with respect to a multi-layer coating. In the uppermost layer, the concentration of surfactant is preferably 0.001-1.000% by weight and most preferably 0.010-0.500%. In addition, lesser amounts of surfactant may be used in the second uppermost layer to minimize diffusion of surfactant into the lowermost layers. The concentration of surfactant in the second uppermost layer is preferably 0.000-0.200% by weight and most preferably between 0.000-0.100% by weight. Because surfactants are only necessary in the uppermost layers, the overall amount of surfactant remaining in the final dried film is small.

Although surfactants are not required to practice the method of the current invention, surfactants do improve the uniformity of the coated film. In particular, mottle nonuniformities are reduced by the use of surfactants. In transparent cellulose acetate films, mottle nonuniformities are not readily visualized during casual inspection. To visualize mottle artifacts, organic dyes may be added to the uppermost layer to add color to the coated film. For these dyed films, non-uniformities are easy to see and quantify. In this way, effective surfactant types and levels may be selected for optimum film uniformity.

The preparation of the cover sheet and guarded cover sheet composite used in the present invention may also include the step of coating over a previously prepared (by coating or casting process) cover sheet film. For example, the coating and drying system 10 shown in FIGS. 1 and 2 may be used to apply a second multi-layer film to an existing low birefringence protective polymer film or cover sheet composite. If the film or cover sheet composite is wound into rolls before applying the subsequent coating, the process is called a multi-pass coating operation. If coating and drying operations are carried out sequentially on a machine with multiple coating stations and drying ovens, then the process is called a tandem coating operation. In this way, thick low birefringence protective polymer films may be prepared at high line speeds without the problems associated with the removal of large amounts of solvent from a very thick wet film. Alternatively, many different cover sheet configurations having various combinations of auxiliary layers applied via a tandem or multi-pass coating operation may be prepared. Moreover, the practice of multi-pass or tandem coating also has the advantage of minimizing other artifacts such as streak severity, mottle severity, and overall film nonuniformity.

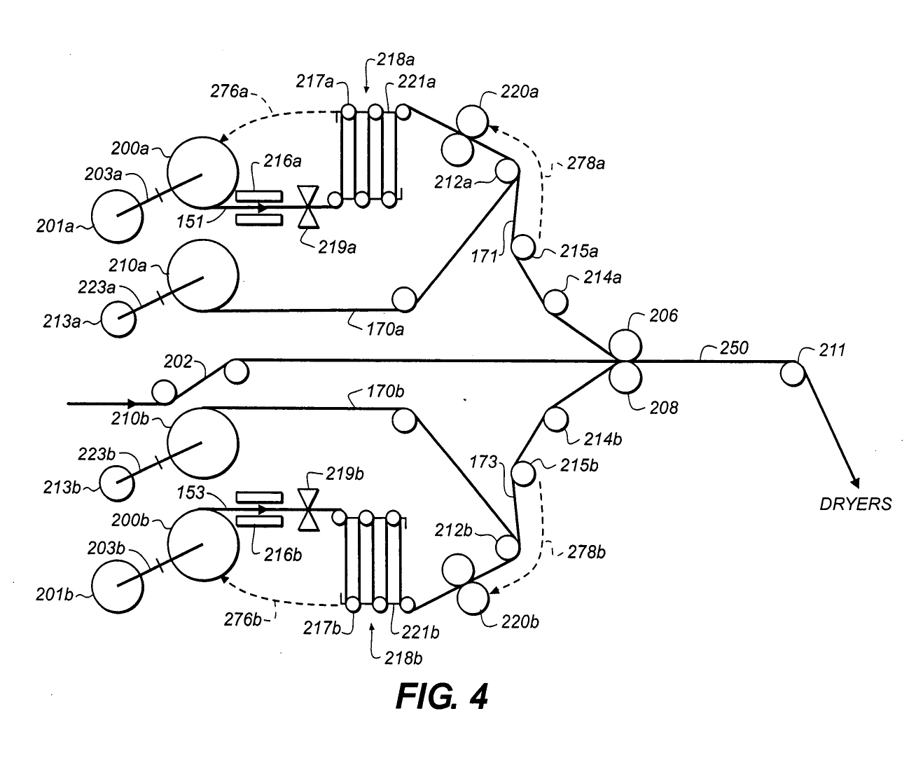

Turning now to FIG. 4, a schematic representation of one embodiment of a method according to the present invention for fabricating a polarizer plate from guarded cover sheet composites of the invention is illustrated. FIG. 4 shows a roll-to-roll process involving web peeling at a peeling station and lamination together of a plurality of webs at a lamination station. For one side of the polarizer plate, guarded cover sheet composite 151 (see FIG. 15) comprising cover sheet 171 and carrier substrate 170 and, for the opposite side of the polarizer plate, a guarded cover sheet composite 153 (see FIG. 16) comprising cover sheet 173 and carrier substrate 170b are supplied from supply rolls 200a and 200b, respectively. A PVA-dichroic film 202 is stretched and dyed with iodide to from a dichroic film in a continuous process prior to being supplied to the lamination station. Prior to entering a lamination nip between opposing pinch rollers 206 and 208, the carrier substrates 170a and 170b are peeled, at a peeling station, from guarded cover sheet composites 151 and 153 to expose a lowermost layer (in the case of FIGS. 15 and 16, this is layer 162, which is the layer promoting adhesion to PVA). The peeled carrier substrates 170a, 170b are wound onto rolls on the carrier winders 210a, 210b. A glue solution may be optionally applied to both 30 sides of the PVA-dichroic film or to the lowermost layer of cover sheets 171 and 173 prior to the sheets and film entering the nip between pinch rollers 206 and 208. The glue solution may be applied by a variety of well known coating methods, including but not limited to spray coating, drip coating, hopper coating, roller coating, blade coating, wire rod coating, etc.

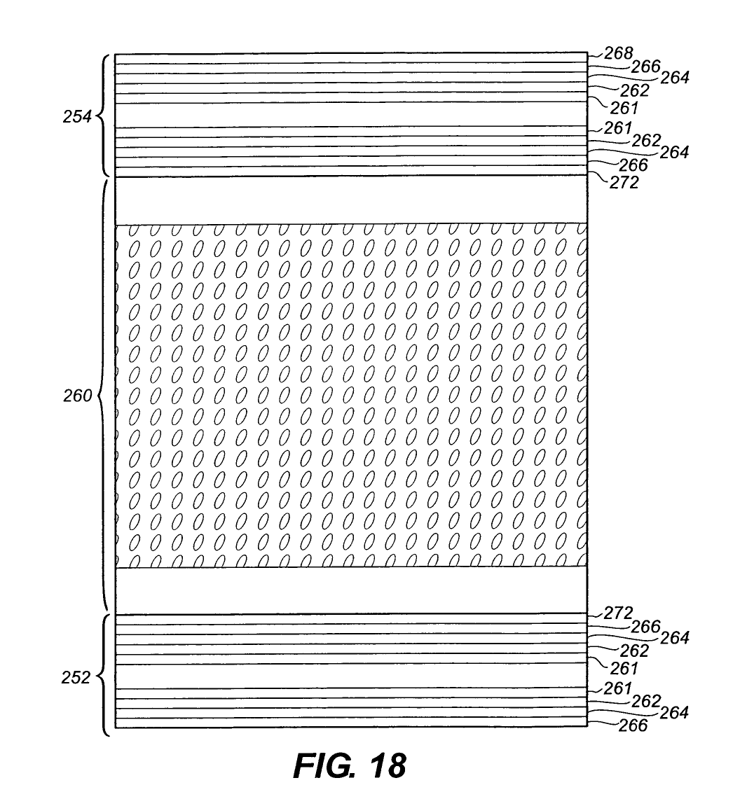

Cover sheets 171 and 173 are laminated to either side of dichroic PVA film 202 with the application of pressure (and, optionally, heat) between the opposing pinch rollers 206 and 208 to give the polarizer plate sheet 250 (which sheets can eventually be finished into individual polarizer plates, such as rear polarizer plate 252 and front polarizer plate 254 in FIG. 18, for individual display devices). Polarizer plate sheet 250 via conveyance roller 211 may then be conveyed to dryers (not shown) for drying, preferably by heating, and wound into rolls until needed. One possible embodiment of the dryers is described in copending U.S. Ser. No. 11/066,785, hereby incorporated by reference. Depending on the particular layer configuration for the guarded cover sheet composites employed, a wide variety of polarizer plates having cover sheets with various combinations of auxiliary layers may be fabricated.

In this particular embodiment, the carrier substrate is preferably a polyester and the protective cover sheet comprises a protective polymer such as TAC plus optional auxiliary layers. The protective cover sheet comprises at least a low birefringence polymer protective film and a layer promoting adhesion to polyvinyl alcohol films.

In the embodiment of FIG. 4, the peeling station comprises peeling rollers 212a, 212b. FIG. 4 further shows a web spreading station comprising bowed (bending) roller 214a, 214b, before the lamination nip, to reduce draw-lines and creases. Following peeling, the carrier web that has been wound onto the carrier winders 210a, 210b can be discarded or recycled at a later time.

In FIG. 4, each of the composite sheets (guarded cover sheet composites) 151, 153 is conveyed in proximity to a means for double-sided splicing 216a, 216b, wherein said means functions to double splice each composite sheet, when expiring, with fresh web. When each of said first or second composite sheet 151, 153 is near to expiring, which can occur independently, each composite sheet is secured to said means for double splicing and then each such expiring composite sheet is double spliced, preferably butt sliced, with a fresh composite sheet such that peeling and laminating steps to follow are maintained in continuous operation.

The means for double splicing can be isolated between supply roll 200a, 200b and a means for isolating tension during splicing, for example, a clamp 219a, 219b. After the means for isolating tension during splicing, each of the composite sheets is conveyed through an accumulator 218a, 218b positioned between clamp 219a, 219b and drive roller 220a, 220b.

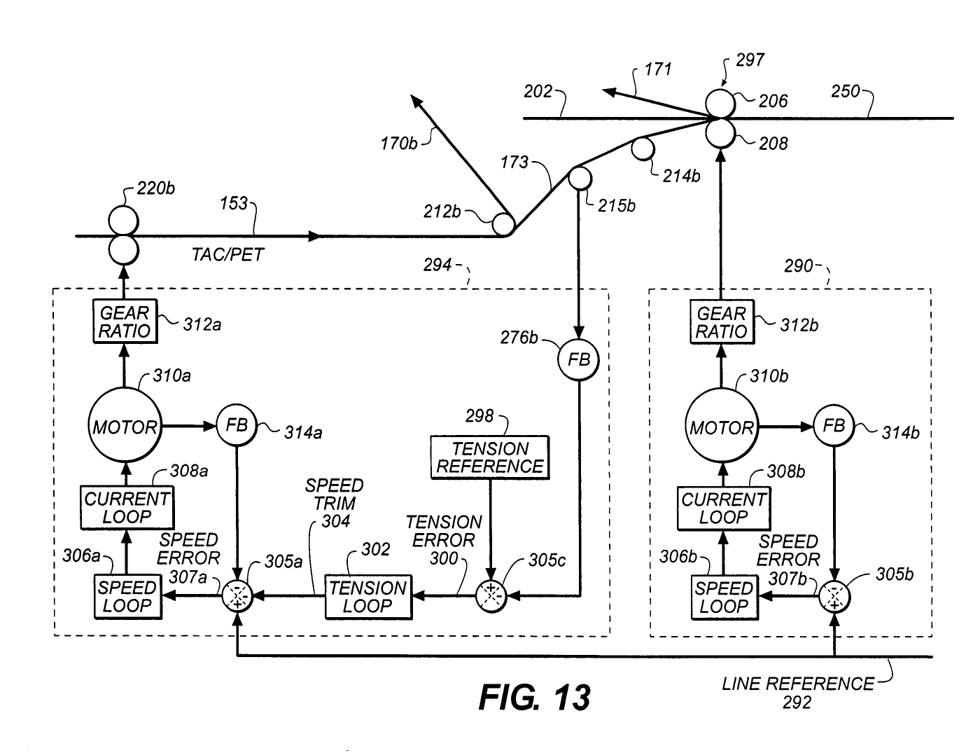

Following the double-sided splicing means 216a, 216b and clamp 219a, 219b, the accumulator 218a, 218b supplies in uninterrupted fashion a laminating station comprising the pinch rollers 206, 208 during the splice cycle. After the accumulator 218a and 218b, the composite sheets 151, 153 are then conveyed into a drive roller 220a, 220b that is used to control the lamination tension of the cover sheet 171 and 173, respectively. The first feedback signal 276a, 276b is used for controlling drive speed of supply rolls 200a and 200b. The second feedback signal 278a, 278b, from load cell roller 215a, 215b, for controlling the drive speed of drive roller 220a, 220b is described in more detail below with respect to FIG. 13.

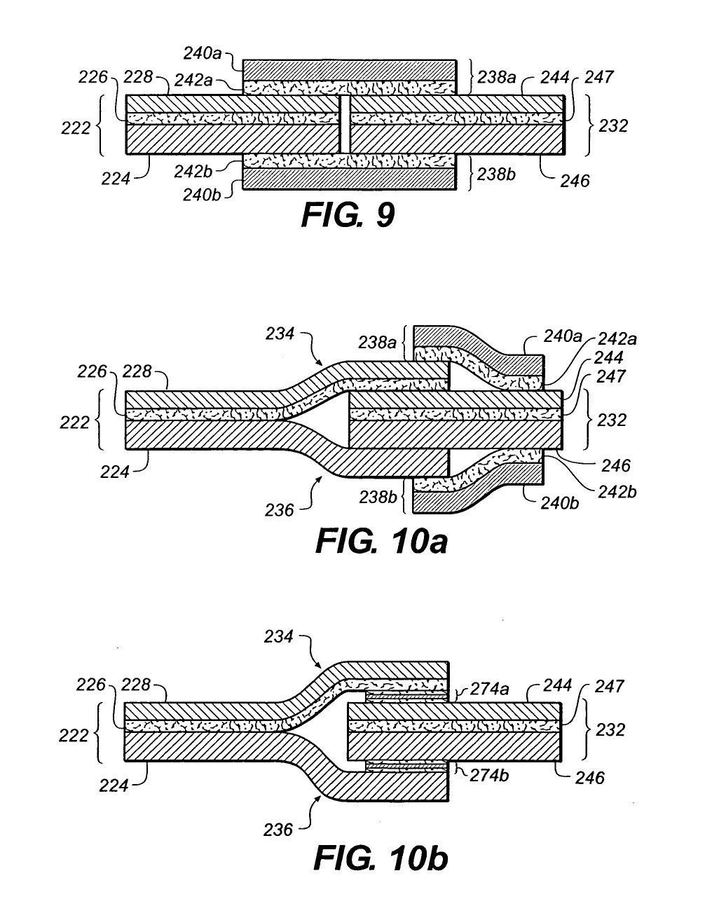

In the embodiment of FIG. 4, prior to the splice sequence, the expiring roll starts its deceleration and the accumulator starts to close allowing the rest of the machine to remain at line speed. The expiring web at this point reaches zero speed. Optionally, sensors and controllers can be employed to bring the fresh web into alignment with the expiring web. See, for example, U.S. Pat. No. 6,016,989 to Gangemi, hereby incorporated by reference. The expiring web is then connected to the fresh web by double layer splicing, as illustrated in FIG. 9, either manually or by an automatic equipment. Alternatively, a double layer lap splice can be applied wherein the fresh web is hand peeled for a short length and the expiring web is sandwiched and adhered between a pre-peeled fresh web as described in more detail below with respect to FIGS. 10a and 10b. The fresh web can be provided from fresh supply roll 201a, 201b of the spindle 203a, 203b, respectively.

After the splice operation, the start of web conveyance involves the fresh web supply roll 201a, 201b accelerating up to a speed greater than line speed allowing the accumulator 218a, 218b to fill with fresh web.

To get ready for the next splice operation, the fresh supply roll 201a, 201b rotates into position. The operator replaces an expiring roll with a fresh roll, allowing the splice cycle to be repeated again. This allows a continuous operating of the peeling and laminating operation downstream of the splicing operation.

With respect to the double splicing operation, preferably this entails a butt splice such as shown in FIG. 9 or an overlap splice as shown in FIGS. 10a and 10b. Overlap (lap) and butt splices are two common types of splices for webs of sheet materials which splices can be made automatically or manually or a combination of partially automatic and partially manual. For an overlap splice, the trailing and leading edges of, respectively, the expiring and fresh rolls of sheet material are typically joined together, for example, by a one-sided adhesive material or by a double-sided adhesive tape. The double-sided adhesive tape can be either a double-coated adhesive tape having a backing member and an adhesive layer on each side or a transfer tape with a single adhesive layer. Such tapes are typically supplied with a single release liner.

Referring more particularly to FIG. 9, one embodiment of a typical permanent butt splice is shown in the figure. The butt splicing would involve the following steps (either manually or by an automated device). A cut is made in the fresh web 222 (comprising fresh carrier sheet 224, fresh adhesive layer 226, and fresh cover sheet 228) to expose a straight edge across the width (perpendicular to machine running direction). Once the expiring roll stops rotating (start of the splice cycle), a straight cut is made on the expiring web 232 (comprising expiring cover sheet 244, expiring carrier sheet 246, and expiring adhesive layer 247) to expose a straight edge across the width. The exposed edges of the expiring web and fresh web are aligned.

Alternatively, these steps can be done (once the expiring roll stops rotating at the start of the splice cycle) by pulling expiring web 232 and overlaying it with the fresh web 222, then making a straight cut through the expiring web 232 and the fresh web 222 to expose a straight edge across the width on both webs. After making the cut, the tails are removed.

A first single-sided tape 238a is used to connect the two cover sheets across the entire width. A second single-sided tape 238b is used to connect the two carrier substrates all across the width. The single-sided tape 238a 238b comprises glue-containing layer 242a, 242b, and backing support 240a, 240b. The splicing cycle is now completed, and the double layer splice can be peeled through continuously at the peeling station. Various other types of butt splicing tapes are disclosed in U.S. Pat. No. 5,212,002 and in the prior art, or known to the skilled artisan.

Referring now to FIGS. 10a and 10b, a typical lap splicing operation may involve the following process steps (either manually or by an automated device). A cut is made in the fresh web 222 (comprising fresh carrier sheet 224, fresh adhesive layer 226 and fresh cover sheet 228) to expose a straight edge across the width (perpendicular to the machine running direction). A short length of the fresh web is peeled to separate the fresh cover sheet 228 from the carrier web 224, thereby forming a pre-peeled cover sheet portion 234 and pre-peeled carrier web portion 236. Once the expiring roll stops rotating (start of the splice cycle), a straight cut is made on the expiring web 232 to expose a straight edge across the width.

When using the single-sided tape 238a, 238b (FIG. 10a), the following steps are performed: The expiring web 232 (no pre-peeling necessary) is positioned between the pre-peeled cover sheet portion 234 and pre-peeled carrier web portion 236 from the fresh roll, making sure the webs are well-aligned.

The single-sided tape 238a, 238b, comprising tape support layer 240a, 240b and glue-containing layer 242a, 242b is employed to connect two (fresh and expiring) web composites 222 and 232, each comprising a guarded cover sheet composite 151 or 153, all across the width.

Referring to FIG. 10b, when using a double-sided tape, the following steps can be performed. Two double-sided tapes 274a, 274b are placed on the expiring web 232 across the web width, one on top of the expiring cover sheet 244 and the other on top of the expiring carrier sheet 246. The expiring web 232 (with tapes) are positioned between the pre-peeled cover sheet portion 234 and the pre-peeled carrier web portion 236 from the fresh roll, making sure the webs align well. The pre-peeled fresh cover sheet portion 234 of the fresh roll is adhered to the expiring cover sheet 244 on the expiring web 232 by the application of pressure, and the pre-peeled carrier web portion of the fresh roll is adhered to the carrier web 246 on the expiring web also by pressure. The splicing cycle is then complete, and the double layer splice can be peeled through continuously at the peeling station.

Such web splicing apparatus accomplishes double splicing of the expiring web with fresh web wherein the line speed on a downstream output side of the accumulator does not substantially fluctuate from a predetermined lamination velocity through the other side of drive rollers 220a, 220b in FIG. 4. In order to achieve this object, the splicing method can include storing a predetermined length of the first and second web in an accumulator.

One common type of accumulator, as exemplified in FIG. 4, comprises upper and lower accumulator rollers 217a, 217b, at least one of which can be moveable, and upper and lower mounting frames 221a, 221b. A change in an amount of the web stored in the accumulator can be determined from a positional change of the movable roller. Specifically, when one or more moveable rollers are moving away from one or more fixed rollers associated with the accumulator, the velocity at which the web is fed out from the supply roll is greater than the velocity at which the web is output from the accumulator (e.g., a line velocity), thereby increasing the amount of the web stored in the accumulator. On the other hand, when the movable rollers are moving toward the fixed rollers, the velocity at which the web is fed out from the supply roll is less than the line velocity, thereby decreasing the amount of the web stored in the accumulator. Thus, when the velocity at which the web is fed out from the supply roll is greater than the line velocity, the amount of the web stored in the accumulator increases, whereas when the velocity at which the web is fed out from the supply roll is smaller than the line velocity, the amount of the web stored in the accumulator decreases.

Accordingly, there is a predetermined relationship between the positional change of the movable rollers (the change per unit time: the velocity of the movable rollers) and the velocity at which the web is fed out from the supply roll. In one embodiment, the velocity at which the web is fed out from the supply roll is equal to the diameter of the roll multiplied by the angular velocity of the roll, whereby the diameter of the roll can be known from the positional change of the movable rollers, the line velocity, and the angular velocity.

Referring still to FIG. 4, the accumulator 218a, 218b can be a scissor-type comprising accumulator rollers 217a, 217b that are movable and a frame 221a, 221b, to which the movable rollers 217a, 217b are attached. Alternatively, the accumulator can include a plurality of movable rollers and a plurality of fixed rollers, around which the web is passed, and a frame to which the movable rollers are attached, as disclosed for example, in US 2003/0209629 A1, hereby incorporated by reference. The composite sheets 151, 153 in FIG. 4 may be placed under tension by a self-weight of the bottom of frame 221a, 221b, or alternatively, an elastic member (not shown) such as a spring or a damper, or a weight, may be attached to the frame 221a, 221b for applying a predetermined tension on the composite sheets 151, 153.

In the accumulator 218a and 218b, the composite sheet 151, 153 is passed around the rollers in a zigzag pattern, and the composite sheet 151, 153 is placed under a predetermined tension as the opposing rollers 217a, 217b connected together via the frames 221a, 221b are moved closer or further away. For example, when more composite sheet 151, 153 is supplied to the accumulator 218a, 218b than is output, the rollers 217a, 217b are moved apart. On the other hand, when more composite sheet 151, 153 is output from the accumulator than is supplied, the rollers are moved toward each other. In other words, the accumulator 218a, 218b can store a predetermined or controllable length of the composite sheet 151, 153, and the composite sheet 151, 153 can be output from the accumulator even if the flow velocity of the composite sheet 151, 153 is zero at the position of input of accumulator 218a, 218b. As a result, the tension on the composite sheet 151, 153 can be kept at a predetermined value.

Moreover, as the number of the rollers 217a, 217b is larger, more composite sheet 151, 153 can be stored in the accumulator 218a, 218b. However, as the number of the rollers 217a, 217b is larger, the tension that can be applied onto the composite sheet 151, 153 by the load on the rollers 217a, 217b are smaller. Thus, as the number of the rollers 217a, 217b are increased, it is necessary to increase the load applied onto the rollers which are connected together.

The accumulator 218a, 218b may be of a type illustrated in FIG. 4, in which the movable rollers are moved up and down. Alternatively, the accumulator 218a, 218b may be of a type in which a supporting rod holds movable rollers, and a pivoting section allows for a pivotal movement of the supporting rod, as disclosed for example, in US 2003/0209629 A1. The web may be placed under tension by the self-weight of the supporting rod. Alternatively, an elastic member such as a spring or a damper, or a weight, may be attached to the supporting rod for applying a predetermined tension on the web, wherein the elastic member is attached at or near one end of the supporting rod that is opposite from the pivoting section.

Normally, the accumulator 218a, 218b in FIG. 4 stores an average amount of the composite sheet 151, 153 between the maximum amount and the minimum amount of the composite sheet 151, 153 that can be stored therein, so that fluctuations in the amount of the composite sheet 151, 153 supplied to the peeling and laminating stations can be optimally accommodated. Before the expiring and fresh webs are spliced together, a controller (not shown) increases the rotational speed of the first driver for the expiring roll so that a predetermined amount of the composite sheet 151, 153 that is greater than the above-mentioned average amount is stored in the accumulator 218a, 218b. The predetermined amount may be of any value as long as it provides a sufficient amount of extra time for splicing the expiring web and the fresh web together.

A controller can be used to turn off the driver when a predetermined amount of the expiring web is stored in the accumulator 218a, 218b in preparation for the splicing of the fresh and expiring webs. When the expiring roll stops spinning, the controller can control the splicer 216a, 216b so that it splices the fresh web to the expiring web and cuts off the expiring web. The amount of the expiring web stored in the accumulator 218a, 218b decreases during the splicing operation. After the expiring web is cut off, the controller turns on the second driver for the fresh roll. Thus, the state of the accumulator 218a, 218b changes during the web splicing process.

After each web is conveyed through the drive rollers 220a, 220b, said carrier substrate 170a, 170b is removed from, respectively, said protective cover sheet 171, 173 at a peeling station to produce, respectively, (i) a first and second unguarded web 171 and 173, each comprising the protective cover sheet, and (ii) a first and second carrier web 170a, 170b each comprising the carrier substrate.

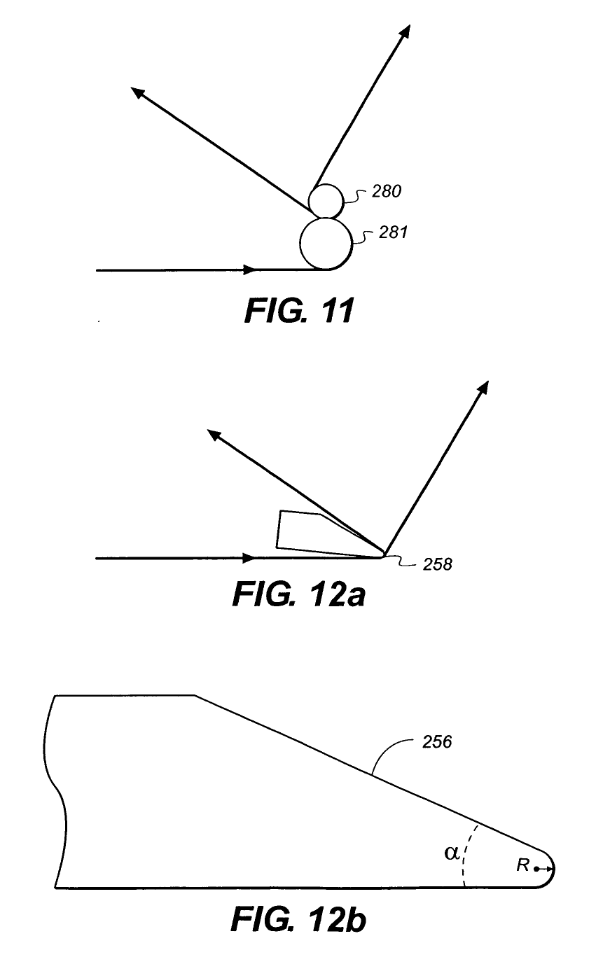

The peeling station comprises a peeling means for separating the unguarded web from the carrier web. Such a peeling means can comprise a single roller 212a, 212b as in FIG. 4 or, alternatively, a contacting nip comprised of two rollers as shown in FIG. 11, a knife as shown in FIGS. 12a and 12b, or a peeling rod, or other means known in the art for peeling.

Such peeling methods can be designed to avoid chatterlines, sticky spots, moving separation lines, and other peeling-related defects. In FIG. 11 web peeling occurs from a nip between two rollers 280 and 281. The rollers can be either bare metallic or rubber covered. The cover rubber hardness can vary from 20 to 85 Shore A Durameter. The nip pressure can range from 1 Newton per meter web width up to 2000 Newtons per meter web width. The use of a roller nip to peel webs apart can fix the position of a separating line (the line where the webs separate), and largely reduces defects due to movement of the separation line.

FIG. 4 shows the peeling of the webs from a single roller 212a, 212b. The roller size can impact peeling quality. Peeling off of a large diameter roller often times generates chatterlines and meandering line-defects at the surface of the webs due to stick and slip behavior between two webs. The generation of chatter-lines can be avoided by reducing the diameter of the peeling roller. The critical diameter at which the chatterline may disappear can depend on the adhesive formula between the layers, and it can vary typically from 10 mm to 200 mm. The peeling roller can be idle or driven. When peeling off a small-size diameter roller, the roller deflection due to the web tension may generate drawlines in the free spans of the web. In that case, a backing roller can be installed to reduce the roller deflection and drawlines.

FIG. 4 shows that, at the peeling station, the carrier web touches the peeling roller. Alternatively at the peeling station, the cover sheet can touch the peeling roller. The diameter of the peeling roller and the arrangement of either carrier web or cover sheet touching peeling roller can be optimized to avoid peeling-related defects such as sticky spots.

FIGS. 12a and 12b show the peeling of the webs from a knife-edge 258 of stationary knife 256. This is in some sense the extreme of peeling on a stationary roller that is very small in size. The knife-edge 258 can be used when peeling defects become an issue with even very small size peeling rollers. On the other hand, due to the fact that the knife edge can be fairly wide, the deflection and thus draw-lines would tend to be less of an issue than with small size peeling rollers. The angle (α) of the knife surface in the vicinity of the peeling location can range from 5 degrees to 170 degrees, and the radius (R) of curvature at the peeling point can suitably range from 0.1 mm to 5 mm.

In preferred peeling configurations (FIGS. 4, 11, 12, etc.), the web tensions in each span can typically vary from 1 to 2000 Newtons per meter web width, preferably from 100 to 1000 Newtons per meter web width. Web wrap angles typically can vary from 2 to 180 degrees.

Experiments have shown that a large amount of electrostatic charge can be generated at the peeling location and at the location where a web is being unwound. To remove or reduce electrostatic charge generation, various means known to the skilled artisan, for example, an tinsel, alpha string, or ionizer may be placed at various locations. One preferred location is following the peeling station or following a bowed roller.

Thus, following the peeling operation, after the peeling point, suitable means (not shown in FIG. 4) for removing an electrostatic charge from the unguarded web can be employed. Likewise, such a means for removing electrostatic charge can be provided in proximity to a supply roll, when the guarded web is removed from the supply roll. A preferred anti-electrostatic means is an alpha string.

Following the accumulator 218a, 218b in FIG. 4, the carrier substrate 170a, 170b is separated or peeled from cover sheet 171, 173. The removed carrier substrate 170a, 170b can be wound onto carrier web winders 210a, 210b and subsequently empty core 213a, 213b of the spindle 223a, 223b.

In one embodiment of the invention, the guarded cover sheet composite is conveyed through an accumulator that is positioned between a supply roll for the guarded cover sheet composite and a peeling station, preferably between a tension isolating means, located after a double-sided splicing means, and a drive roller. Optionally, the carrier substrate after being peeled is conveyed through a different accumulator positioned between the peeling station and a carrier web winder.

In another embodiment of the invention, the composite polarizer sheet is conveyed through an accumulator positioned between a laminator nip and a winder for the composite polarizer sheet. Preferably, this accumulator is positioned between the laminator nip and a dryer for the composite polarizer sheet.

Depending on the position of the one or more accumulators, the peeling station and the lamination station can also be continuous during steady state operation.

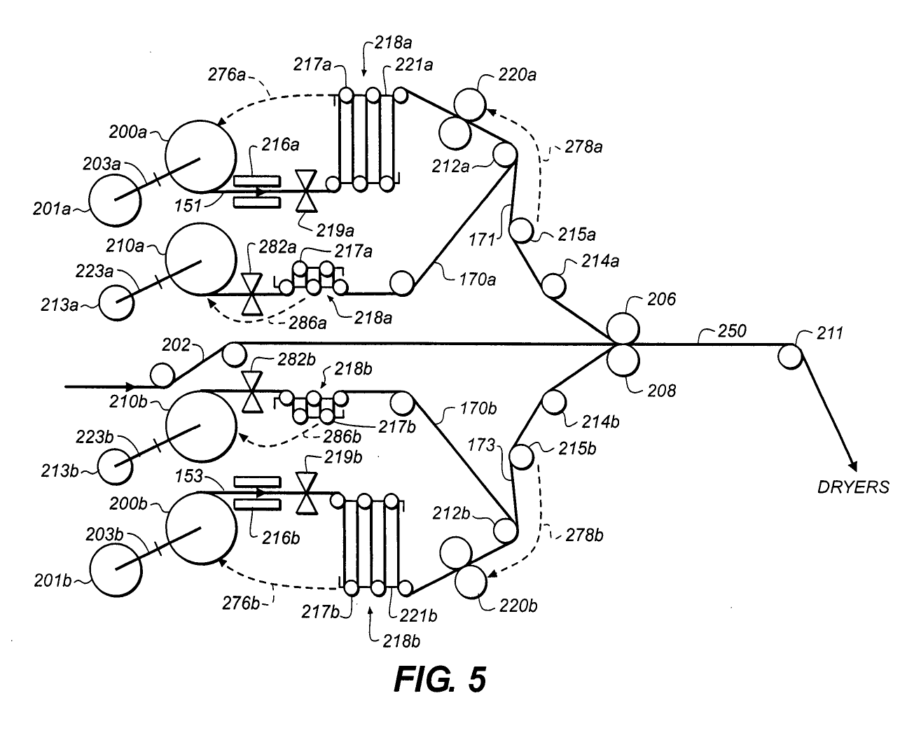

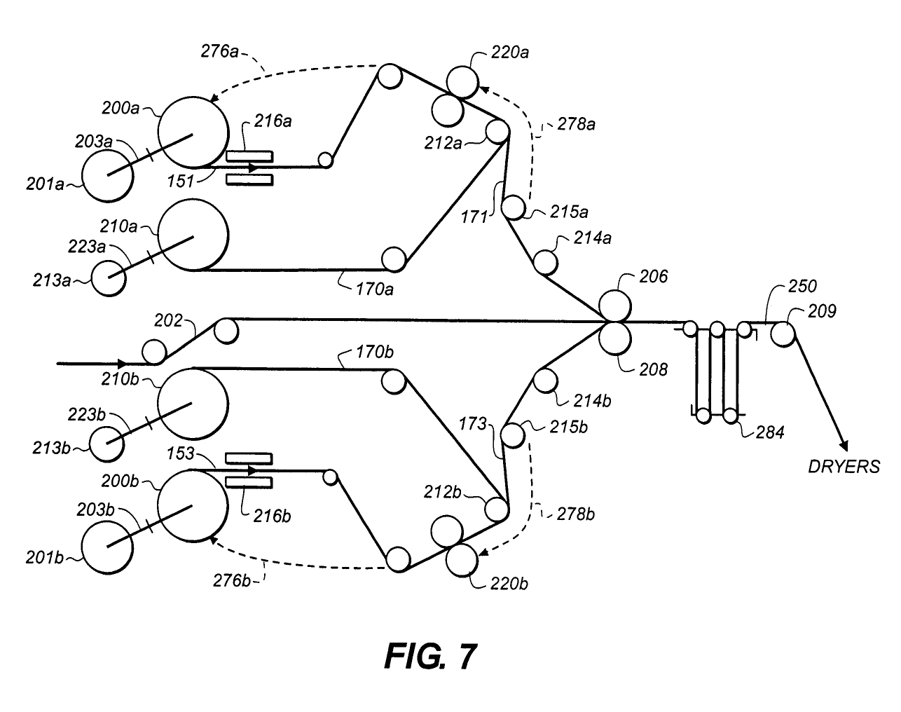

Thus, accumulators may be used in various locations as illustrated in FIGS. 4 to 7. In comparison to the embodiment of FIG. 4, for example, in the embodiment shown in FIG. 7, accumulators are not used between the double sided splicing and peeling operation. Also, in the embodiments shown in FIGS. 4 and 5, the removed carrier web can be conveyed with or without employing an accumulator and wound onto a winding spindle. Still alternatively, the removed carrier web can merely be disposed of by being sent to a waste chopper, preferably for recycling.

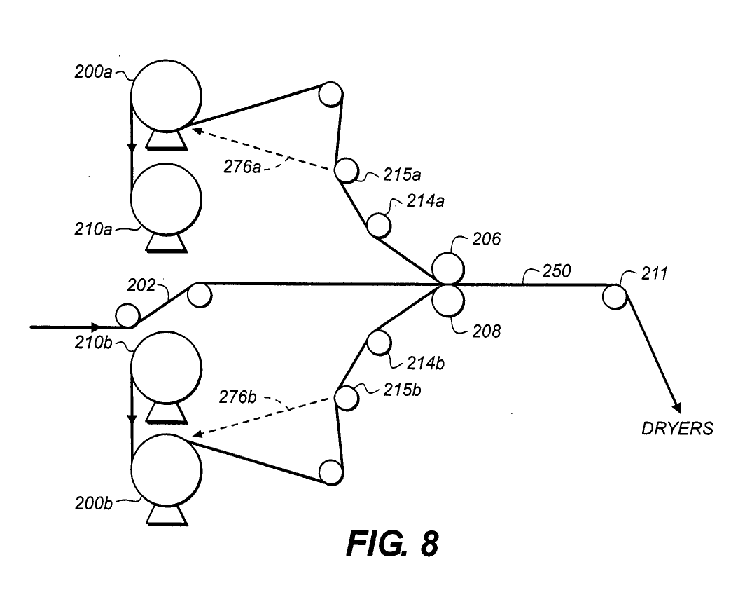

In yet another aspect of the present invention, accumulators are not necessary, as shown in FIG. 8, discussed below.

Subsequent to the peeling station in FIG. 4, each unguarded web is conveyed over means for controlling tension, for example a load cell roller or float roller 215a, 215b, having feedback control to said second means for isolating tension (tension isolation drive roller 220 a, b in FIG. 4).

Following the load cell roller 215 a, b, each unguarded web is then conveyed over a means for spreading the web, suitably removing wrinkles, which is especially advantageous for relatively thin webs. This may be accomplished by a variety of means, including a bowed or bending roller, concave roller, flex roller, or the like.

In the embodiment of the invention shown in FIG. 4, following the peeling station, the unguarded web is conveyed over a means for spreading the web such as a bowed (bending) roller 214a, 214b. This avoids problems such as wrinkles that are a very common problem with resin film. Because webs have very little lateral compressive stiffness, wrinkles often occur. Web-spreading or anti-wrinkle rollers are called upon to perform a spectrum of activity from stretching a web, to spreading a web, to allowing a web to flatten out or simply not inducing wrinkles in the first place.

Web spreading devices include, for example, bowed rollers, expanding surface rollers, rubber spreader rollers, grooved metal rollers, and reverse taper rollers. Bowed rollers are a particularly effective web spreading device for use in the present invention. A bowed roller is a flexible roller of consistent diameter that is mounted on a central shaft by way of a series of bearings or sleeves along the shaft. When a curvature is induced into the shaft, the result is a bow in the roller face. Bowed rollers remove wrinkles or spread the web because the web will attempt to orient itself at a right angle along the face of the roller, thus pulling each side of the web in different directions. Also, as the web wraps the roller, it has to travel a longer distance at the center and is therefore tighter.

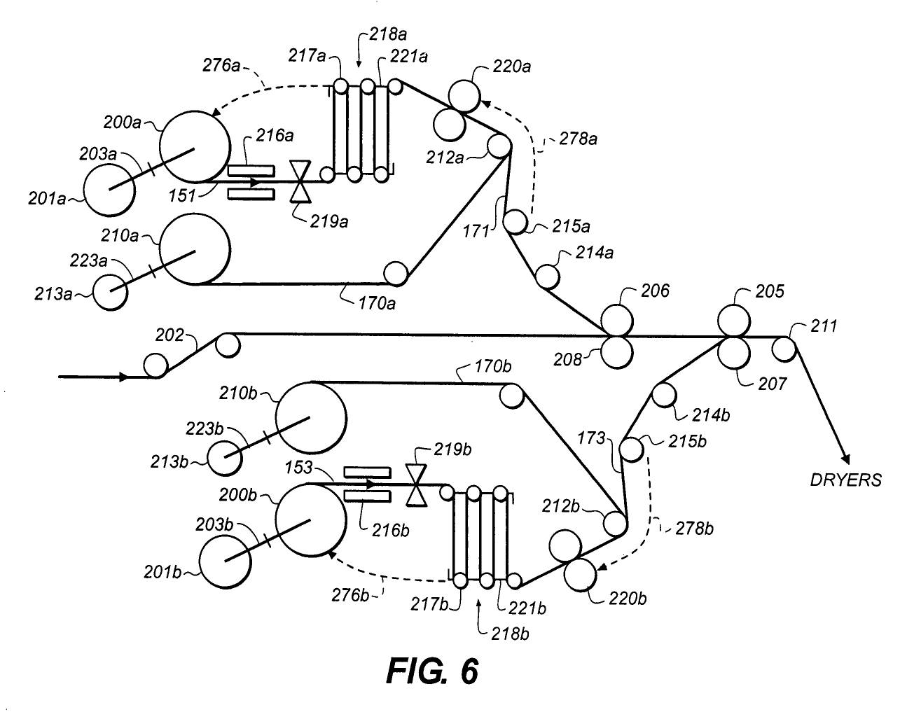

Each unguarded web 171, 173 in FIG. 4 is then brought, either simultaneously or sequentially, into contact with a polarizing web 202 comprising a dichroic PVA film such that each layer promoting adhesion to polyvinyl alcohol, in each of said two unguarded webs, are contacted with said polarizing web, for example, a dichroic PVA film, wherein pressure is applied as said PVA dichroic film and cover sheets are brought into contact, thereby forming a polarizer plate web 250. In the embodiment of FIG. 4, this occurs simultaneously, whereas in the embodiment of FIG. 6, this is accomplished sequentially.

Following the lamination, the polarizer plate web can be dried, either by positive measures, usually to speed the process, or by allowing the web to dry. The polarizing plate web after drying can be wound on a winding spindle (not shown).

Optionally, glue can be applied to the unguarded web or polarizing web prior to contact between the two webs. Alternatively, the glue can be applied to the unguarded web between the peeling station and the lamination nip. An example of a glue composition is described below.

Optionally, each of said first and second webs may be heated prior to peeling at a peeling point, to facilitate the peeling operation.

The protective cover sheet used in FIGS. 4 to 7 can comprise one or more functional/auxiliary layers as described below, for example, a moisture barrier layer, antistatic layer, compensation layer, hard coat, antiglare, or anti-reflection layer. Usually, the hard coat, antiglare, or anti-reflection layers are on the side of the low birefringence polymer protective film opposite to the layer promoting adhesion to polyvinyl alcohol films (PVA and crosslinker).

Turning next to FIGS. 5 through 8, there are presented cross-sectional illustrations showing various cover sheet and guarded cover sheet process configurations possible with the present invention. The same parts in different figures are numbered the same, particularly in FIGS. 4 through 8. Hence, for a description of a part not discussed in a subsequent figure, reference is made to previous figures.

The process of FIG. 5 differs from that of FIG. 4 only in that carrier web 170a, 170b, after being peeled from the guarded cover sheet composite 171 and 173, is conveyed through a carrier-web accumulator roller 280a, 280b and means for isolating tension, such as supplemental clamp 282a, 282b, during roll transfer. A feedback signal 286a, 286b to carrier winder can be used to control the drive speed of the winder 210a, 210b, which in turn controls the tension of the carrier web leading to the winder 210a, 210b. An advantage of this embodiment is that it facilitates the change of rolls, when a winding roll becomes full with carrier web, by allowing zero speed transfer.

Referring next to FIG. 6, each unguarded web 171, 173 is brought sequentially, rather than simultaneously, into contact with a polarizing web 202 comprising the dichroic PVA film such that each layer promoting adhesion to polyvinyl alcohol, in each of said two unguarded webs, are contacted sequentially with the polarizing web, for example, a dichroic PVA film. Pressure is applied as the PVA dichroic film and each cover sheet is brought into contact, thereby forming a polarizer plate web 250. More particularly, as shown in FIG. 6, unguarded web 171, 173 is first laminated to polarizing web 202 between lamination pinch rollers 206 and 208. Subsequently, unguarded web 171, 173 is then laminated to the other side of the polarizing web 202 between downstream lamination pinch rollers 205, 207. As stated above, following the lamination, the polarizer plate web can be dried, either by positive measures, usually to speed the process, or by allowing the web to dry. The polarizing plate web after drying is wound on a winder (not shown).

The other parts in FIG. 6 are as described in previous FIG. 4. An advantage of sequential lamination is that nip pressures can be independently controlled for different cover sheets having different materials, structures, or dimensions.

Referring now to FIG. 7, another design in accordance with the invention allows a reduction in the number of accumulators, which provides a simpler web path. A post-lamination accumulator 284 is positioned between a laminating station represented by lamination pinch rollers 206, 208 and a conveyance roller, preferably a downstream bowed roller 209. The presence of the post-lamination accumulator 284 allows roll transfer of the supply rolls 200a, 200b and carrier winders 210a, 210b. However, in this case, the lamination stops temporarily while the windup of the polarizer plate sheet 250 can occur uninterrupted. While lamination stops, the roll transfer can occur at any of the four spindles 203a, 203b and 223a, 223b, either manually or automatically. In this embodiment, control of the lamination station to change the glue supply or to vary the pressure or timing of lamination may be desirable to compensate for the temporary line interruption.

FIG. 8 is a still simpler embodiment of a process according to the present invention, in which no accumulators are employed. This embodiment is a batch process in which the lamination, and substantially the entire process, has to be stopped during roll transfer. In the illustrated process, the peeling is shown occurring directly at the supply rolls 200a, 200b without a separate peeling station. Alternatively, the peeling can occur at a separate peeling station as shown in FIGS. 4 through 7. In any case, the peeling and the lamination in FIG. 8 needs to be stopped (as well as the supply of polarizer web) during the roll change of supply roll 200a, 200b or (if employed) the carrier winders 210a and 210b. In this embodiment, the tension control of the web resides in load cell roller 215a, 215b, which provides a feedback signal to the unwinding spindle to adjust the drive speed. A web length counter may be employed to sense the approach of the end of a web or it can be visually determined. A detector to monitor the diameter of the winding roll can also be used to assess the web duration. At this point, the process can be stopped and preparations for roll transfer can be made. This batch process is more desirable for small-scale operation, whereas the continuous processes of FIGS. 4-7 are more amenable for larger scale commercial production.

As mentioned above, one aspect of the present invention relates to controlling the tension of at least the cover sheet following peeling of the carrier substrate therefrom. Controlling the tension of the cover sheet can comprise sensing a parameter associated with the cover sheet after peeling, which parameter bears a direct or indirect relation (not necessarily explicit) to the tension of the cover sheet, and comparing the sensed parameter to a set point. Typically, the parameter is the tension of the cover sheet or is a dimensional or positional characteristic of the cover sheet that intrinsically is related to tension of the cover sheet. The comparison can then be used to generate a signal for controlling a means for conveying the guarded cover sheet composite prior to the peeling. At the same time, in a preferred embodiment, the speed of the nip rollers in the lamination station can be maintained by a master drive.

In one embodiment, the conveying means is a drive roller located before a peeling station for peeling the carrier substrate from the cover sheet and after the supply roll for the guarded cover sheet composite. In another embodiment, the conveying means is an unwinder for the guarded cover sheet composite that supplies the guarded cover sheet composite to a peeling station for peeling the carrier substrate from the cover sheet. For example, the speed of the conveying means can be increased when the sensed parameter indicates that either the tension of the cover sheet is too high or the amount or portion, such as length, of the guarded cover sheet composite in the vicinity of a means for sensing the parameter needs to be increased. Alternatively, the sensed parameter can be a sensing means that measures a distance related to a displacement of the cover sheet in a vicinity of the sensing means. Thus, the sensing means can, for example, employ a sensing means that measures the tension of the cover sheet, either indirectly or directly. Such a sensing means can, for example, be a float roller or load cell.

Preferably, the tension of the cover sheet is maintained within a set range during steady state operation of the method, and the set point is between 30 Newtons per meter and 1000 Newtons per meter, preferably 200 to 300 Newtons per meter. The variation of the tension of the cover sheet that is sensed during steady state operation (that is, after start up and before shut down operation) is preferably maintained within 15 percent, more preferably 5 percent, of the set point.

Referring next to FIG. 13, one embodiment of a process control scheme is illustrated for controlling the tension in the cover sheet 173 after being peeled from guarded cover sheet composite 153 at peeling roller 212 b. (Thus, the process control for the bottom portion of, for example, a process according to FIGS. 4 to 7 is being illustrated, whereas the same or similar process control can be used for the top portion of a process such as in FIGS. 4 to 7). In particular, the tension of a cover sheet 173 is controlled by a drive roller 220 b which can be viewed as a tension trimmed drive means. A load cell roller 215b that functions as a feedback sensor generates a signal proportional to the amount of web between the laminating pinch rollers (206, 208) and the drive roller 220 b.

The pinch rollers 206, 208 comprise a master drive 297 that uses lamination-nip-drive control block (290) to control its speed relative to line speed reference 292.

The speed of the drive roller 220 b is varied from line speed reference 292 by tension-trimmed-drive control block 294 which maintains the desired web tension in the cover sheet 173 prior to the lamination pinch rollers 206, 208.

Although the embodiment of FIG. 13 shows a load cell roller 215b as the feedback mechanism for controlling the tension trimmed drive, an alternative means is a float roller. Still other methods can be used, as will be appreciated by the skilled artisan. With a load cell, the feedback signal is typically proportional to web tension. With a float roller, the feedback signal is typically proportional to a float arm position. In this case, the float arm sets web tension, and the tension drive prevents the float roller from running out of travel (slack or tight).

In operation of the process control scheme of FIG. 13, if tension of unguarded cover sheet 173 is too high, the tension trimmed drive is speeded up. If tension of 173 is too low, then the tension trimmed drive 220 b is slowed down. If the speed of master drive 297 is too high compared to line speed reference 292, the master drive is slowed down.

As mentioned above, tension of a second cover sheet 171 can be controlled prior to the lamination nip in a similar fashion.

The control blocks 290 and 294 for the embodiment shown in FIG. 13 are by themselves of conventional design, as will be understood by the skilled artisan. In this embodiment, such a control block comprises integrator 305c comparing a feedback signal 276b from the load cell 215b to a reference tension 298 (tension set point), the difference of which generates tension error 300. The tension error is converted to a speed trim 304 via a tension loop software 302, which speed trim is basically a speed correction that feeds back to an inner speed loop control block comprising an integrator 305a, speed loop software 306a, and current loop 308a that provides electric current to motor 310a which drives via gear box 312a a tension trimmed drive 220b. The speed trim 304 together with the line reference speed 292 and the feedback signal 314a from the motor generates the speed error 307a fed to speed loop software 306.

With respect to control block 290 in FIG. 13, the present embodiment comprises a drive integrator 305b that takes the feedback signal 314b from motor 310b and line speed reference 292 to generate a speed error 307b that feeds to speed loop software 306b, current loop 308b, and motor 310b, analogously to the control block 294. The motor 310b, via gear box 312b controls the master drive 297.

It should be mentioned that in the case of the process of FIG. 7, the master drive 297 will be a drive roller (not shown) downstream of the accumulator 284, instead of the lamination pinch rollers 206, 208.

The process of the present invention, as indicated above, can use two cover sheet composites, one on each side of the polarizer film. These two cover sheet composites can have different structures or materials. The process with respect to each cover sheet, although the same in FIGS. 4 to 8, can differ. For example, the process steps with respect to the first cover sheet composite 151 shown in FIG. 4, which steps are above the polarizer film and up to but not including the lamination station, can be changed to the analogous process steps in FIG. 5 while keeping the process steps with respect to the second cover sheet composite 153 the same. Similarly, the process steps with respect to the first cover sheet composite 151 shown in FIG. 6 (shown above the polarizer film in FIG. 6), up to but not including the lamination station, can be changed to the analogous process steps in FIG. 5 while keeping the process steps with respect to the second cover sheet composite 153 the same. Similarly, other combinations of process steps with respect to the two cover sheet composites, with appropriate modification if necessary, can be devised as desired under particular circumstances.

Still alternatively, only one half of the process of FIGS. 4 to 8 may be employed, in which only one cover sheet composites is peeled and laminated to the polarizer film. In this case, only one cover sheet composite enters the pinch rollers 206, 208 in FIG. 4, FIG. 5, FIG. 7, and FIG. 8. Similarly, the pinch rollers 205, 207 can be eliminated in FIG. 6. The resulting product can be later laminated to other optical films, before or after being wound up.

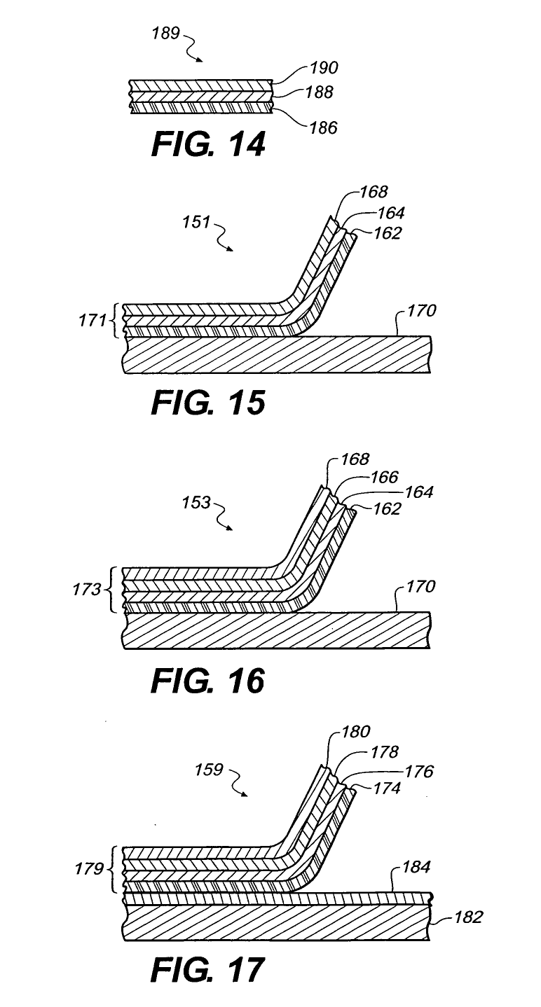

Turning next to FIGS. 14 through 17, they are presented cross-sectional illustrations showing various cover sheet and guarded cover sheet configurations possible for use with the present invention. FIG. 14 shows a cover sheet 189 having lower-most layer 186, intermediate layer 188, and uppermost layer 190. In this illustration, layer 186 could be a layer promoting adhesion to PVA, 188 could be a tie layer, and layer 190 could be a low birefringence protective polymer film. An optional additional layer (not shown), between layer 188 and 190, could be an auxiliary layer such as a viewing angle compensation layer, moisture barrier layer, abrasion resistant layer, or other type of auxiliary layer, for example. The cover sheet may be prepared by conventional casting methods or by coating methods employing a carrier substrate as described hereinabove.

In FIG. 15, a guarded cover sheet composite 151 comprising a three-layer cover sheet 171 having lower-most layer 162, intermediate layer 164, and uppermost layer 168 is shown partially peeled from a carrier substrate 170. In this illustration, layer 162 could be a layer promoting adhesion to PVA, layer 164 could be a tie layer, and layer 168 could be a low birefringence protective polymer film. Layers 162, 164, and 168 may be formed either by applying and drying three separate liquid layers on the carrier substrate 170 or by simultaneously applying two or all three of the layers and then drying those simultaneously applied layers in a single drying operation.

In a preferred embodiment, the layer promoting adhesion to PVA is coated and dried separately from the tie layer and low birefringence protective polymer film using a water-based coating formulation. When a cover sheet 171 is prepared by coating onto a carrier substrate 170 as illustrated in FIG. 15, it is generally preferred that the layer promoting adhesion to PVA is coated onto the carrier substrate 170 and then dried, prior to application of the low birefringence protective polymer film. Auxiliary layers may be applied either simultaneously with the low birefringence protective polymer film or in a subsequent coating and drying operation.

FIG. 16 illustrates another guarded cover sheet composite 153 comprising a cover sheet 173 that is comprised of, for example, four compositionally discrete layers including a lowermost layer 162 nearest to the carrier support 170, two intermediate layers 164 and 166, and an uppermost layer 168. FIG. 16 also shows that the entire multiple layer cover sheet 173 may be peeled from the carrier substrate 170. In this illustration, layer 162 could be a layer promoting adhesion to PVA, layer 164 could be a tie layer, layer 166 could be a low birefringence protective polymer film, and layer 168 could be an auxiliary layer such as an abrasion resistant layer, for example.

FIG. 17 illustrates a further guarded cover sheet composite 159 comprising a cover sheet 179 that is comprised of, for example, four compositionally discrete layers including a lowermost layer 174 nearest to the carrier substrate 182, two intermediate layers 176 and 178, and an uppermost layer 180. The carrier substrate 182 has been treated with a release layer 184 to modify the adhesion between the cover sheet lowermost layer 174 and substrate 182. Release layer 184 may be comprised of a number of polymeric materials such as polyvinylbutyrals, cellulosics, polyacrylates, polycarbonates and poly(acrylonitrile-co-vinylidene chloride-co-acrylic acid). The choice of materials used in the release layer may be optimized empirically by those skilled in the art.

FIGS. 14 through 17 serve to illustrate some of the guarded cover sheet composites that may be constructed based on the detailed teachings provided hereinabove. They are not, however, intended to be exhaustive of all possible variations of the invention. One skilled in the art could conceive of many other layer combinations that would be useful as guarded cover sheet composites for use in the preparation of polarizer plates for LCDs which various guarded cover sheet composites are amendable to use as a supply web for the process of the present invention.

As mentioned above, with respect to the present process, when the cover sheet is laminated to the dichroic PVA film such that the layer promoting adhesion to PVA is on the side of the cover sheet that contacts the PVA dichroic film, a glue solution can be used for laminating the cover film and the Dichroic PVA film. A wide variety of glue compositions are available and is not particularly limited. A commonly employed example is a water/alcohol solution containing a dissolved polymer such as PVA or its derivatives and a boron compound such as boric acid. Alternatively, the solution may be free or substantially free of dissolved polymer and comprise a reagent that crosslinks PVA. The reagent may crosslink PVA either ionically or covalently or a combination of both types of reagents may be used. Appropriate crosslinking ions include but are not limited to cations such as calcium, magnesium, barium, strontium, boron, beryllium, aluminum, iron, copper, cobalt, lead, silver, zirconium and zinc ions. Boron compounds such as boric acid and zirconium compounds such as zirconium nitrate or zirconium carbonate are particularly preferred. Examples of covalent crosslinking reagents include polycarboxylic acids or anhydrides; polyamines; epihalohydrins; diepoxides; dialdehydes; diols; carboxylic acid halides, ketenes and like compounds. The amount of the solution applied onto the films can vary widely depending on its composition. For example, a wet film coverage as low as 1 cc/m² and as high as 100 cc/m² are possible. Low wet film coverages are desirable to reduce the drying time needed.

Low birefringence protective polymer films suitable for use in the present invention comprise polymeric materials having low Intrinsic Birefringence Δnᵢₙₜ that form high clarity films with high light transmission (i.e., >85%). Preferably, the low birefringence protective polymer film has in-plane birefringence, Δnᵢₙ of less than about 1×10⁻⁴ and an out-of-plane birefringence, Δnₜₕ of from 0.005 to −0.005.

Exemplary polymeric materials for use in the low birefringence protective polymer films include cellulose esters (including triacetyl cellulose (TAC), cellulose diacetate, cellulose acetate butyrate, cellulose acetate propionate), polycarbonates (such as LEXAN available from General Electric Corp., bisphenol-A-trimethylcyclohexane-polycarbonate, bisphenol-A-phthalate-polycarbonate), polysulfones (such as UDEL available from Amoco Performance Products Inc.), polyacrylates, and cyclic olefin polymers (such as ARTON available from JSR Corp., ZEONEX and ZEONOR available from Nippon Zeon, TOPAS supplied by Ticona), among others. Preferably, the low birefringence protective polymer film of the invention comprises TAC, polycarbonate, or cyclic olefin polymers due their commercial availability and excellent optical properties.

The low birefringence protective polymer film has a thickness from about 5 to 200 micrometers, preferably from about 5 to 80 micrometers and most preferably from about 20 to 80 micrometers. Films having thickness of 20 to 80 micrometers are most preferred due to cost, handling, and the ability to fabricate thinner polarizer plates. In a preferred embodiment of the current invention, polarizer plates assembled from cover sheets of the invention have a total thickness of less than 120 micrometers, and most preferably less than 80 micrometers.

The layer promoting adhesion to PVA preferably comprises a hydrophilic polymer. Hydrophilic polymers suitable for the purpose of the present invention include both synthetic and natural polymers. Naturally occurring polymers include proteins, protein derivatives, cellulose derivatives (e.g. cellulose esters), polysaccharides, casein, and the like, and synthetic polymers include poly(vinyl lactams), acrylamide polymers, polyvinyl alcohol and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers, vinyl imidazole copolymers, vinyl sulfide copolymers, homopolymer or copolymers containing styrene sulfonic acid, and the like.

Preferably, the hydrophilic polymer is water-soluble. The most preferred hydrophilic polymers are polyvinyl alcohol and its derivatives. Particularly preferred polyvinyl alcohol polymers have a degree of hydrolysis of between 75 and 99.5% and have a weight average molecular weight of greater than 10,000.

In one embodiment, the layer promoting adhesion to polyvinyl alcohol films may further comprise hydrophobic polymer particles such as water dispersible polymers and polymer latexes. Preferably these polymer particles contain hydrogen-bonding accepting groups, which includes hydroxyl, carboxyl, amino, or sulfonyl moieties. Suitable polymer particles comprise addition-type polymers and interpolymers prepared from ethylenically unsaturated monomers such as acrylates including acrylic acid, methacrylates including methacrylic acid, acrylamides and methacrylamides, itaconic acid and its half esters and diesters, styrenes including substituted styrenes, acrylonitrile and methacrylonitrile, vinyl acetates, vinyl ethers, vinyl and vinylidene halides, and olefins. In addition, crosslinking and graft-linking monomers such as 1,4-butyleneglycol methacrylate, trimethylolpropane triacrylate, allyl methacrylate, diallyl phthalate, divinyl benzene, and the like may be used. Other suitable polymer dispersions are polyurethane dispersions or polyester ionomer dispersions, polyurethane/vinyl polymer dispersions, and fluoropolymer dispersions. Preferably, polymers for use in the polymer particles of the invention have a weight average molecular weight of greater than about 10,000 and a glass transition temperature (Tg) of less than about 25° C. In general, high molecular weight, low Tg polymer particles provide improved adhesion of the layer to both PVA dichroic films and the tie layer.

These polymer particles can have a particle size in the range of from 10 nanometers to 1 micron, preferably from 10 to 500 nanometers, and most preferably from 10 to 200 nanometers. Suitably, the polymer particles can comprise between 5 and 40 weight % of the layer promoting adhesion to PVA in such an embodiment.

The layer promoting adhesion to PVA may also contain a crosslinking agent. Crosslinking agents useful for the practice of the invention include any compounds that are capable of reacting with reactive moieties present on the water soluble polymer and/or polymer particles. Such crosslinking agents include aldehydes and related compounds, pyridiniums, olefins such as bis(vinylsulfonyl methyl) ether, carbodiimides, epoxides, triazines, polyfunctional aziridines, methoxyalkyl melamines, polyisocyanates, and the like. These compounds can be readily prepared using the published synthetic procedure or routine modifications that would be readily apparent to one skilled in the art of synthetic organic chemistry. Additional crosslinking agents that may also be successfully employed in the layer promoting adhesion to PVA include multivalent metal ion such as zinc, calcium, zirconium and titanium.

The layer promoting adhesion to PVA is typically applied at a dried coating weight of 50 to 3000 mg/m², preferably 250 to 1000 mg/m². The layer is highly transparent and, preferably, has a light transmission of greater than 95%.

For the guarded cover sheet composites use in the invention, preferably the layer promoting adhesion to PVA is on the same side of the low birefringence protective polymer film as the carrier substrate. Most preferably, the layer promoting adhesion to PVA is applied directly onto the carrier substrate or onto a subbing layer on the carrier substrate. The layer promoting adhesion to PVA may be coated in a separate coating application or it may be applied simultaneously with one or more other layers.

In order to provide good wetting by the water-based glues that may be employed to laminate the cover sheets of the invention to PVA dichroic films, it is preferred that the PVA adhesion promoting layer has a water contact angle of less than 20°. The adhesion promoting layer also preferably has a water swell of between 20 and 1000% to promote good contact and perhaps intermixing of the adhesion promoting layer with the glue and/or PVA dichroic film.

In one embodiment, an optional tie layer can comprises at least 50 weight % of a polymer having an acid number of between 20 and 200 that is soluble in organic solvent at 20° C. Preferably the acid functionality is a carboxylic acid. Polymer suitable for use in the tie layer include interpolymers of ethylenically unsaturated monomers comprising carboxylic acid groups, acid-containing cellulosic polymers such as cellulose acid phthalate and cellulose acetate trimellitate, polyurethanes having carboxylic acid groups, and others. Suitable interpolymers of ethylenically unsaturated monomers comprising carboxylic acid groups include acrylates including acrylic acid, methacrylates including methacrylic acid, acrylamides and methacrylamides, itaconic acid and its half esters and diesters, styrenes including substituted styrenes, acrylonitrile and methacrylonitrile, vinyl acetates, vinyl ethers, vinyl and vinylidene halides, and olefins.

Organic solvents suitable for solubilizing and coating the tie layer polymer include chlorinated solvents (methylene chloride and 1,2 dichloroethane), alcohols (methanol, ethanol, n-propanol, isopropanol, n-butanol, isobutanol, diacetone alcohol and cyclohexanol), ketones (acetone, methylethyl ketone, methylisobutyl ketone, and cyclohexanone), esters (methyl acetate, ethyl acetate, n-propyl acetate, isopropyl acetate, isobutyl acetate, n-butyl acetate, and methylacetoacetate), aromatics (toluene and xylenes) and ethers (1,3-dioxolane, 1,2-dioxolane, 1,3-dioxane, 1,4-dioxane, and 1,5-dioxane). In some applications, small amounts of water may be used. Normally, the coating solutions are prepared with a blend of the aforementioned solvents. Preferred primary solvents include methylene chloride, acetone, methyl acetate, and 1,3-dioxolane. Preferred co-solvents for use with the primary solvents include methanol, ethanol, n-butanol and water. Preferably, the tie layer polymer is applied from the same or at least compatible solvent mixture to the low birefringence protective polymer.

The tie layer may also contain a crosslinking agent. Crosslinking agents useful for the practice of the invention include any compounds that are capable of reacting with reactive moieties present on the polymer, particularly carboxylic acid. Such crosslinking agents include aldehydes and related compounds, pyridiniums, olefins such as bis(vinylsulfonyl methyl) ether, carbodiimides, epoxides, triazines, polyfunctional aziridines, methoxyalkyl melamines, polyisocyanates, and the like. These compounds can be readily prepared using the published synthetic procedure or routine modifications that would be readily apparent to one skilled in the art of synthetic organic chemistry. Additional crosslinking agents that may also be successfully employed in the layer include multivalent metal ion such as zinc, calcium, zirconium and titanium.

The optional tie layer is typically applied at a dried coating weight of 50 to 5000 mg/m², preferably 500 to 5000 mg/m² and has a thickness of preferably 0.5 to 5 micrometers. The layer is highly transparent and, preferably, has a light transmission of greater than 95%.

The tie layer can be applied onto an already coated and dried layer promoting adhesion to PVA. The tie layer may be coated in a separate coating application or it may be applied simultaneously with one or more other layers. Preferably, for best adherence, the tie layer is applied simultaneously with the low birefringence protective polymer layer.

Carrier substrates suitable for the use in the present invention include polyethylene terephthalate (PET), polyethylene naphthalate (PEN), polycarbonate, polystyrene, and other polymeric films. Additional substrates may include paper, laminates of paper and polymeric films, glass, cloth, aluminum and other metal supports. Preferably, the carrier substrate is a polyester film comprising polyethylene terephthalate (PET) or polyethylene naphthalate (PEN). The thickness of the carrier substrate is about 20 to 200 micrometers, typically about 40 to 100 micrometers. Thinner carrier substrates are desirable due to both cost and the weight per roll of guarded cover sheet composite. However, carrier substrates less than about 20 micrometers may not provide sufficient dimensional stability or protection for the cover sheet.

The carrier substrate may be coated with one or more subbing layers or may be pretreated with electrical discharge devices to enhance the wetting of the substrate by coating solutions. Since the cover sheet must ultimately be peeled from the carrier substrate the adhesion between cover sheet and substrate is an important consideration. Subbing layers and electrical discharge devices may also be employed to modify the adhesion of the cover sheet to the carrier substrate. Subbing layers may therefore function as either primer layers to improve wetting or release layers to modify the adhesion of the cover sheet to the substrate. The carrier substrate may be coated with two subbing layers, the first layer acting as a primer layer to improve wetting and the second layer acting as a release layer. The thickness of the subbing layer is typically 0.05 to 5 micrometers, preferably 0.1 to 1 micrometers.

Cover sheet/substrate composites having poor adhesion might be prone to blister after application of a second or third wet coating in a multi-pass operation. To avoid blister defects, adhesion should be greater than about 0.3 N/m between the first-pass layer of the cover sheet and the carrier substrate. As already mentioned, the level of adhesion may be modified by a variety of web treatments including various subbing layers and various electronic discharge treatments. However, excessive adhesion between the cover sheet and substrate is also undesirable since the cover sheet may be damaged during subsequent peeling operations. In particular, cover sheet/substrate composites having too great an adhesive force may peel poorly. The maximum adhesive force that allows acceptable peel behavior is dependent on the thickness and tensile properties of the cover sheet. Typically, an adhesive force between the cover sheet and the substrate greater than about 300 N/m may peel poorly. Cover sheets peeled from such excessively well-adhered composites exhibit defects due to tearing of the cover sheet and/or due to cohesive failure within the sheet. In a preferred embodiment of the present invention, the adhesion between the cover sheet and the carrier substrate is less than 250 N/m. Most preferably, the adhesion between the cover sheet and the carrier substrate is between 0.5 and 25 N/m.

In a preferred embodiment of the invention, the carrier substrate is a polyethylene terephthalate film having a first subbing layer (primer layer) comprising a vinylidene chloride copolymer and second subbing layer (release layer) comprising polyvinyl butyral. In another preferred embodiment of the invention the carrier substrate is polyethylene terephthalate film that has been pretreated with a corona discharge prior to application of the cover sheet.

Substrates may also have functional layers such as antistatic layers containing various polymer binders and conductive addenda in order to control static charging and dirt and dust attraction. The antistatic layer may be on either side of the carrier substrate, preferably it is on the side of the carrier substrate opposite to the cover sheet.

On the side of the substrate opposite to the cover sheet a backing layer may also be employed in order to provide a surface having appropriate roughness and coefficient of friction for good winding and conveyance characteristics. In particular, the backing layer comprises a polymeric binder such as a polyurethane or acrylic polymer containing matting agent such a silica or polymeric beads. The matting agent helps to prevent the sticking of the front side of the guarded cover sheet composite to the backside during shipping and storage. The backing layer may also comprise a lubricant to provide a coefficient of friction of about 0.2 to 0.4. Typical lubricants include for example (1) liquid paraffin and paraffin or wax like materials such as carnauba wax, natural and synthetic waxes, petroleum waxes, mineral waxes and the like; (2) higher fatty acids and derivatives, higher alcohols and derivatives, metal salts of higher fatty acids, higher fatty acid esters, higher fatty acid amides, polyhydric alcohol esters of higher fatty acids, etc., disclosed in U.S. Pat. Nos. 2,454,043; 2,732,305; 2,976,148; 3,206,311; 3,933,516; 2,588,765; 3,121,060; 3,502,473; 3,042,222; and 4,427,964, in British Patents 1,263,722; 1,198,387; 1,430,997; 1,466,304; 1,320,757; 1,320,565; and 1,320,756; and in German Patents 1,284,295 and 1,284,294; (3) perfluoro- or fluoro- or fluorochloro-containing materials, which include poly(tetrafluoroethylene), poly(trifluorochloroethylene), poly(vinylidene fluoride, poly(trifluorochloroethylene-co-vinyl chloride), poly(meth)acrylates or poly(meth)acrylamides containing perfluoroalkyl side groups, and the like. However for lasting lubricity a polymerizable lubricant such as ADDITIVE 31, a methacryloxy-functional silicone polyether copolymer (from Dow Corning Corp.) is preferred.

In another embodiment, the guarded cover sheet composite comprises a strippable, protection layer on the surface of the cover sheet opposite to the carrier substrate. The strippable, protection layer may be applied by coating the layer or it may be applied by adhesively adhering or by electrostatically adhering, a preformed protection layer. Preferably, the protection layer is a transparent polymer layer. In one particular embodiment, the protection layer is a low birefringence layer that allows optical inspection of the cover sheet without the need to remove the protection layer. Particularly useful polymers for use in the protection layer include: cellulose esters, acrylics, polyurethanes, polyesters, cyclic olefin polymers, polystyrene, polyvinyl butyral, polycarbonate, and others. When a preformed protection layer is used, it is preferably a layer of polyester, polystyrene, or polyolefin film.

The strippable, protection layer is typically 5 to 100 micrometers in thickness. Preferably, the protection layer is 20 to 50 micrometers thick to insure adequate resistance to scratch and abrasion and provide easy handling during removal of the protection layer.

When the strippable, protection layer is applied by coating methods it may be applied to an already coated and dried cover sheet or the protection layer may be coated simultaneously with one or more layers comprising the cover sheet.

When the strippable, protection layer is a preformed layer it may have a pressure sensitive adhesive layer on one surface that allows the protection layer to be adhesively laminated to the guarded cover sheet composite using conventional lamination techniques. Alternatively, the preformed protection layer may be applied by generating an electrostatic charge on a surface of the cover sheet or the preformed protection layer and then bringing the two materials into contact in a roller nip. The electrostatic charge may be generated by any known electric charge generator, e.g., a corona charger, a tribocharger, conducting high potential roll charge generator or contact charger, a static charge generator, and the like. The cover sheet or the preformed protection layer may be charged with a DC charge or a DC charge followed by an AC charge in order to create an adequate level of charge adhesion between the two surfaces. The level of electrostatic charge applied to provide a sufficient bond between the cover sheet and the preformed protection layer is at least more than 50 volts, preferably at least more than 200 volts. The charged surface of the cover sheet or the protection layer has a resistivity of at least about 10¹² Ω/square, preferably at least about 10¹⁶ Ω/square in order to insure that the electrostatic charge is long lasting.

As mentioned above, each cover sheet may have various auxiliary layers that are necessary to improve the performance of the Liquid Crystal Display. Useful auxiliary layers that may be employed in the cover sheets used in the invention include: abrasion resistant hardcoat layer, antiglare layer, anti-smudge layer or stain-resistant layer, antireflection layer, low reflection layer, antistatic layer, viewing angle compensation layer, and moisture barrier layer. Typically, the cover sheet closest to the viewer contains one or more of the following auxiliary layers: the abrasion resistant layer, anti-smudge or stain-resistant layer, antireflection layer, and antiglare layer. One or both of the cover sheets closest to the liquid crystal cell typically contain a viewing angle compensation layer. Any or all of the four cover sheets employed in the LCD may optionally contain an antistatic layer and a moisture barrier layer.

The cover sheets may contain an abrasion resistant layer on the opposite side of the low birefringence protective polymer film to the layer promoting adhesion to PVA.

Particularly effective abrasion resistant layers comprise radiation or thermally cured compositions, and preferably the composition is radiation cured. Ultraviolet (UV) radiation and electron beam radiation are the most commonly employed radiation curing methods. UV curable compositions are particularly useful for creating the abrasion resistant layer of this invention and may be cured using two major types of curing chemistries, free radical chemistry and cationic chemistry. Acrylate monomers (reactive diluents) and oligomers (reactive resins and lacquers) are the primary components of the free radical based formulations, giving the cured coating most of its physical characteristics. Photo-initiators are required to absorb the UV light energy, decompose to form free radicals, and attack the acrylate group C═C double bond to initiate polymerization. Cationic chemistry utilizes cycloaliphatic epoxy resins and vinyl ether monomers as the primary components. Photo-initiators absorb the UV light to form a Lewis acid, which attacks the epoxy ring initiating polymerization. By UV curing is meant ultraviolet curing and involves the use of UV radiation of wavelengths between 280 and 420 nm preferably between 320 and 410 nm.

Examples of UV radiation curable resins and lacquers usable for an abrasion layer are those derived from photo polymerizable monomers and oligomers such as acrylate and methacrylate oligomers (the term “(meth)acrylate” used herein refers to acrylate and methacrylate), of polyfunctional compounds, such as polyhydric alcohols and their derivatives having (meth)acrylate functional groups such as ethoxylated trimethylolpropane tri(meth)acrylate, tripropylene glycol di(meth)acrylate, trimethylolpropane tri(meth)acrylate, diethylene glycol di(meth)acrylate, pentaerythritol tetra(meth)acrylate, pentaerythritol tri(meth)acrylate, dipentaerythritol hexa(meth)acrylate, 1,6-hexanediol di(meth)acrylate, or neopentyl glycol di(meth)acrylate and mixtures thereof, and acrylate and methacrylate oligomers derived from low-molecular weight polyester resin, polyether resin, epoxy resin, polyurethane resin, alkyd resin, spiroacetal resin, epoxy acrylates, polybutadiene resin, and polythiol-polyene resin, and the like and mixtures thereof, and ionizing radiation-curable resins containing a relatively large amount of a reactive diluent. Reactive diluents usable herein include monofunctional monomers, such as ethyl (meth)acrylate, ethylhexyl (meth)acrylate, styrene, vinyltoluene, and N-vinylpyrrolidone, and polyfunctional monomers, for example, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

Among others, conveniently used radiation curable lacquers include urethane (meth)acrylate oligomers. These are derived from reacting diisocyanates with a oligo(poly)ester or oligo(poly)ether polyol to yield an isocyanate terminated urethane. Subsequently, hydroxy terminated acrylates are reacted with the terminal isocyanate groups. This acrylation provides the unsaturation to the ends of the oligomer. The aliphatic or aromatic nature of the urethane acrylate is determined by the choice of diisocyanates. An aromatic diisocyanate, such as toluene diisocyanate, will yield an aromatic urethane acrylate oligomer. An aliphatic urethane acrylate will result from the selection of an aliphatic diisocyanate, such as isophorone diisocyanate or hexyl methyl diisocyanate. Beyond the choice of isocyanate, polyol backbone plays a pivotal role in determining the performance of the final the oligomer. Polyols are generally classified as esters, ethers, or a combination of these two. The oligomer backbone is terminated by two or more acrylate or methacrylate units, which serve as reactive sites for free radical initiated polymerization. Choices among isocyanates, polyols, and acrylate or methacrylate termination units allow considerable latitude in the development of urethane acrylate oligomers. Urethane acrylates, like most oligomers, are typically high in molecular weight and viscosity. These oligomers are multifunctional and contain multiple reactive sites. Because of the increased number of reactive sites, the cure rate is improved and the final product is cross-linked. The oligomer functionality can vary from 2 to 6.

Among others, conveniently used radiation curable resins include polyfunctional acrylic compounds derived from polyhydric alcohols and their derivatives such as mixtures of acrylate derivatives of pentaerythritol such as pentaerythritol tetraacrylate and pentaerythritol triacrylate functionalized aliphatic urethanes derived from isophorone diisocyanate. Some examples of urethane acrylate oligomers used in the practice of this invention that are commercially available include oligomers from Sartomer Company (Exton, Pa.). An example of a resin that is conveniently used in the practice of this invention is CN 968 from Sartomer Company.

A photo-polymerization initiator, such as an acetophenone compound, a benzophenone compound, Michler's benzoyl benzoate, α-amyloxime ester, or a thioxanthone compound and a photosensitizer such as n-butyl amine, triethylamine, or tri-n-butyl phosphine, or a mixture thereof is incorporated in the ultraviolet radiation curing composition. In the present invention, conveniently used initiators are 1-hydroxycyclohexyl phenyl ketone and 2-methyl-1-[4-(methyl thio)phenyl]-2-morpholinopropanone-1.

The abrasion resistant layer is typically applied after coating and drying the low birefringence protective polymer film. The abrasion resistant layer of this invention is applied as a coating composition that typically also includes organic solvents. Preferably the concentration of organic solvent is 1-99% by weight of the total coating composition.

Examples of solvents employable for coating the abrasion resistant layer include solvents such as methanol, ethanol, propanol, butanol, cyclohexane, heptane, toluene and xylene, esters such as methyl acetate, ethyl acetate, propyl acetate and mixtures thereof. With the proper choice of solvent, adhesion of the abrasion resistant layer can be improved while minimizing migration of plasticizers and other addenda from the low birefringence protective polymer film, enabling the hardness of the abrasion resistant layer to be maintained. Suitable solvents for TAC low birefringence protective polymer film are aromatic hydrocarbon and ester solvents such as toluene and propyl acetate.

The UV polymerizable monomers and oligomers are coated and dried, and subsequently exposed to UV radiation to form an optically clear cross-linked abrasion resistant layer. The preferred UV cure dosage is between 50 and 1000 mJ/cm².

The thickness of the optional abrasion resistant layer is generally about 0.5 to 50 micrometers preferably 1 to 20 micrometers, more preferably 2 to 10 micrometers.

The abrasion resistant layer is preferably colorless, but it is specifically contemplated that this layer can have some color for the purposes of color correction, or for special effects, so long as it does not detrimentally affect the formation or viewing of the display through the overcoat. Thus, there can be incorporated into the polymer dyes that will impart color. In addition, additives can be incorporated into the polymer that will give to the layer desired properties. Other additional compounds may be added to the coating composition, including surfactants, emulsifiers, coating aids, lubricants, matte particles, rheology modifiers, crosslinking agents, antifoggants, inorganic fillers such as conductive and nonconductive metal oxide particles, pigments, magnetic particles, biocide, and the like.

The abrasion resistant layer typically provides a layer having a pencil hardness (using the Standard Test Method for Hardness by Pencil Test ASTM D3363) of at least 2H and preferably 2H to 8H.

The cover sheets used in the invention may contain an antiglare layer, a low reflection layer or an antireflection layer on the same side of the carrier substrate as the low birefringence protective polymer film. The antiglare layer, low reflection layer or antireflection layer is located on the opposite side of the low birefringence protective polymer film to the layer promoting adhesion to PVA. Such layers are employed in an LCD in order to improve the viewing characteristics of the display, particularly when it is viewed in bright ambient light. The refractive index of an abrasion resistant, hard coat is about 1.50, while the index of the surrounding air is 1.00. This difference in refractive index produces a reflection from the surface of about 4%.

An antiglare coating provides a roughened or textured surface that is used to reduce specular reflection. All of the unwanted reflected light is still present, but it is scattered rather than specularly reflected. For the purpose of the present invention, the antiglare coating preferably comprises a radiation cured composition that has a textured or roughened surface obtained by the addition of organic or inorganic (matting) particles or by embossing the surface. The radiation cured compositions described hereinabove for the abrasion resistant layer are also effectively employed in the antiglare layer. Surface roughness is preferably obtained by the addition of matting particles to the radiation cured composition. Suitable particles include inorganic compounds having an oxide, nitride, sulfide or halide of a metal, metal oxides being particularly preferred. As the metal atom, Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb and Ni are suitable, and Mg, Ca, B and Si are more preferable. An inorganic compound containing two types of metal may also be used. A particularly preferable inorganic compound is silicon dioxide, namely silica.

Additional particles suitable for use in the optional antiglare layer include the layered clays described in commonly-assigned U.S. patent application Ser. No. 10/690,123, filed Oct. 21, 2003. The most suitable layered particles include materials in the shape of plates with high aspect ratio, which is the ratio of a long direction to a short direction in an asymmetric particle. Preferred layered particles are natural clays, especially natural smectite clay such as montmorillonite, nontronite, beidellite, volkonskoite, hectorite, saponite, sauconite, sobockite, stevensite, svinfordite, halloysite, magadiite, kenyaite and vermiculite as well as layered double hydroxides or hydrotalcites. Most preferred clay materials include natural montmorillonite, hectorite and hydrotalcites, because of commercial availability of these materials.

Suitable layered materials may comprise phyllosilicates, for example, montmorillonite, particularly sodium montmorillonite, magnesium montmorillonite, and/or calcium montmorillonite, nontronite, beidellite, volkonskoite, hectorite, saponite, sauconite, sobockite, stevensite, svinfordite, vermiculite, magadiite, kenyaite, talc, mica, kaolinite, and mixtures thereof. Other useful layered materials may include illite, mixed layered illite/smectite minerals, such as ledikite and admixtures of illites with the layered materials named above. Other useful layered materials, particularly useful with anionic matrix polymers, may include the layered double hydroxide clays or hydrotalcites, such as Mg₆Al_{3.4}(OH)_{18.8}(CO₃)_{1.7}H₂O, which have positively charged layers and exchangeable anions in the interlayer spaces. Preferred layered materials are swellable so that other agents, usually organic ions or molecules, may splay, that is, intercalate and/or exfoliate, the layered material resulting in a desirable dispersion of the inorganic phase. These swellable layered materials include phyllosilicates of the 2:1 type, as defined in the literature (for example, “An introduction to clay colloid chemistry,” by H. van Olphen, John Wiley & Sons Publishers). Typical phyllosilicates with ion exchange capacity of 50 to 300 milliequivalents per 100 grams are preferred. Generally, it is desirable to treat the selected clay material to separate the agglomerates of platelet particles to small crystals, also called tactoids, prior to introducing the platelet particles to the antiglare coating. Predispersing or separating the platelet particles also improves the binder/platelet interface. Any treatment that achieves the above goals may be used. Examples of useful treatments include intercalation with water soluble or water insoluble polymers, organic reagents or monomers, silane compounds, metals or organometallics, organic cations to effect cation exchange, and their combinations.

Additional particles for use in the optional antiglare layer include polymer matte particles or beads which are well known in the art. The polymer particles may be solid or porous, preferably they are crosslinked polymer particles. Porous polymer particles for use in an antiglare layer are described in commonly-assigned U.S. patent application Ser. No. 10/715,706, filed Nov. 18, 2003.

Particles for use in the antiglare layer have an average particle size ranging from 2 to 20 micrometers, preferably from 2 to 15 micrometers and most preferably from 4 to 10 micrometers. They are present in the layer in an amount of at least 2 wt percent and less than 50 percent, typically from about 2 to 40 wt. percent, preferably from 2 to 20 percent and most preferably from 2 to 10 percent.

The thickness of the antiglare layer is generally about 0.5 to 50 micrometers preferably 1 to 20 micrometers more preferably 2 to 10 micrometers.

Preferably, the antiglare layer has a 60° Gloss value, according to ASTM D523, of less than 100, preferably less than 90 and a transmission haze value, according to ASTM D-1003 and JIS K-7105 methods, of less than 50%, preferably less than 30%.

In another embodiment, a low reflection layer or antireflection layer is used in combination with an abrasion resistant hard coat layer or antiglare layer. The low reflection or antireflection coating is applied on top of the abrasion resistant or antiglare layer. Typically, a low reflection layer provides an average specular reflectance (as measured by a spectrophotometer and averaged over the wavelength range of 450 to 650 nm) of less than 2%. Antireflection layers provide average specular reflectance values of less than 1%.

Suitable low reflection layers for the cover sheet comprise fluorine-containing homopolymers or copolymers having a refractive index of less than 1.48, preferably with a refractive index between about 1.35 and 1.40. Suitable fluorine-containing homopolymers and copolymers include: fluoro-olefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid, and completely or partially fluorinated vinyl ethers, and the like. The effectiveness of the layer may be improved by the incorporation of submicron-sized inorganic particles or polymer particles that induce interstitial air voids within the coating. This technique is further described in U.S. Pat. No. 6,210,858 and U.S. Pat. No. 5,919,555. Further improvement of the effectiveness of the low reflection layer may be realized with the restriction of air voids to the internal particle space of submicron-sized polymer particles with reduced coating haze penalty, as described in commonly-assigned U.S. patent application Ser. No. 10/715,655, filed Nov. 18, 2003.

The thickness of the optional low reflection layer is 0.01 to 1 micrometer and preferably 0.05 to 0.2 micrometer.

An antireflection layer may comprise a monolayer or a multi-layer. Antireflection layers comprising a monolayer typically provide reflectance values less than 1% at only a single wavelength (within the broader range of 450 to 650 nm). A commonly employed monolayer antireflection coating that is suitable for use in the present invention comprises a layer of a metal fluoride such as magnesium fluoride (MgF₂). The layer may be applied by well-known vacuum deposition technique or by a sol-gel technique. Typically, such a layer has an optical thickness (i.e., the product of refractive index of the layer times layer thickness) of approximately one quarter-wavelength at the wavelength where a reflectance minimum is desired.

Although a monolayer can effectively reduce the reflection of light within a very narrow wavelength range, more often a multi-layer comprising several (typically, metal oxide based) transparent layers superimposed on one another is used to reduce reflection over a wide wavelength region (i.e., broadband reflection control). For such a structure, half wavelength layers are alternated with quarter wavelength layers to improve performance. The multi-layer antireflection coating may comprise two, three, four, or even more layers. Formation of this multi-layer typically requires a complicated process comprising a number of vapor deposition procedures or sol-gel coatings, which correspond to the number of layers, each layer having a predetermined refractive index and thickness. Precise control of the thickness of each layer is required for these interference layers. The design of suitable multi-layer antireflection coatings for use in the present invention is well known in the patent art and technical literature, as well as being described in various textbooks, for example, in H. A. Macleod, “Thin Film Optical Filters,” Adam Hilger, Ltd., Bristol 1985 and James D. Rancourt, “Optical Thin Films User's Handbook”, Macmillan Publishing Company, 1987.

The cover sheets used in the invention may also contain a moisture barrier layer. The moisture barrier layer typically comprises a hydrophobic polymer such as a vinylidene chloride polymer, vinylidene fluoride polymer, polyurethane, polyolefin, fluorinated polyolefin, polycarbonate, and others, having a low moisture permeability. Preferably, the hydrophobic polymer comprises vinylidene chloride. More preferably, the hydrophobic polymer comprises 70 to 99 weight percent of vinylidene chloride. The moisture barrier layer may be applied by application of an organic solvent-based or aqueous coating formulation. To provide effective moisture barrier properties the layer should be at least 1 micrometer in thickness, preferably from 1 to 10 micrometers in thickness, and most preferably from 2 to 8 micrometers in thickness. The cover sheet of the invention comprising a moisture barrier layer has a moisture vapor transmission rate (MVTR) according to ASTM F-1249 that is less than 1000 g/m²/day, preferably less than 800 g/m²/day and most preferably less than 500 g/m²/day. The use of such a barrier layer in the cover sheet of the invention provides improved resistance to changes in humidity and increased durability of the polarizer plate comprising the cover sheet, especially for TAC cover sheets having a thickness less than about 40 micrometers.

The cover sheets used in the invention may contain a transparent antistatic layer. The antistatic layer aids in the control of static charging that may occur during the manufacture and use of the cover sheet composite. Effective control of static charging reduces the propensity for the attraction of dirt and dust to the cover sheet composite. The guarded cover sheet composite may be particularly prone to triboelectric charging during the peeling of the cover sheet from the carrier substrate. The so-called “separation charge” that results from the separation of the cover sheet and the substrate can be effectively controlled by an antistatic layer having a resistivity of less than about 1×10¹¹ Ω/square, preferably less than 1×10¹⁰ Ω/square, and most preferably less than 1×10⁹ Ω/square.

Various polymeric binders and conductive materials may be employed in the antistatic layer. Polymeric binders useful in the antistatic layer include any of the polymers commonly used in the coating art, for example, interpolymers of ethylenically unsaturated monomers, cellulose derivatives, polyurethanes, polyesters, hydrophilic colloids such as gelatin, polyvinyl alcohol, polyvinyl pyrrolidone, and others.

Conductive materials employed in the antistatic layer may be either ionically-conductive or electronically-conductive. Ionically-conductive materials include simple inorganic salts, alkali metal salts of surfactants, polymeric electrolytes containing alkali metal salts, and colloidal metal oxide sols (stabilized by metal salts). Of these, ionically-conductive polymers such as anionic alkali metal salts of styrene sulfonic acid copolymers and cationic quaternary ammonium polymers of U.S. Pat. No. 4,070,189 and ionically-conductive colloidal metal oxide sols which include silica, tin oxide, titania, antimony oxide, zirconium oxide, alumina-coated silica, alumina, boehmite, and smectite clays are preferred.

The optional antistatic layer preferably contains an electronically-conductive material due to their humidity and temperature independent conductivity. Suitable materials include:

1) electronically-conductive metal-containing particles including donor-doped metal oxides, metal oxides containing oxygen deficiencies, and conductive nitrides, carbides, and bromides. Specific examples of particularly useful particles include conductive SnO₂, In₂O, ZnSb₂O₆, InSbO₄, TiB₂, ZrB₂, NbB₂, TaB₂, CrB, MoB, WB, LaB₆, ZrN, TiN, WC, HfC, HfN, and ZrC. Examples of the patents describing these electrically conductive particles include; U.S. Pat. Nos. 4,275,103; 4,394,441; 4,416,963; 4,418,141; 4,431,764; 4,495,276; 4,571,361; 4,999,276; 5,122,445; and 5,368,995;

2) fibrous electronic conductive particles comprising, for example, antimony-doped tin oxide coated onto non-conductive potassium titanate whiskers as described in U.S. Pat. Nos. 4,845,369 and 5,166,666, antimony-doped tin oxide fibers or whiskers as described in U.S. Pat. Nos. 5,719,016 and 5,0731,119, and the silver-doped vanadium pentoxide fibers described in U.S. Pat. No. 4,203,769; and

3) electronically-conductive polyacetylenes, polythiophenes, and polypyrroles, preferably the polyethylene dioxythiophene described in U.S. Pat. No. 5,370,981 and commercially available from Bayer Corp. as BAYTRON P.

The amount of the conductive agent used in the antistatic layer can vary widely depending on the conductive agent employed. For example, useful amounts range from about 0.5 mg/m² to about 1000 mg/m², preferably from about 1 mg/m² to about 500 mg/m². The antistatic layer has a thickness of from 0.05 to 5 micrometers, preferably from 0.1 to 0.5 micrometers to insure high transparency.

Since contrast, color reproduction, and stable gray scale intensities are important quality attributes for electronic displays that employ liquid crystal technology. The primary factor limiting the contrast of a liquid crystal display is the propensity for light to “leak” through liquid crystal elements or cells, which are in the dark or “black” pixel state. Furthermore, the leakage and hence contrast of a liquid crystal display are also dependent on the direction from which the display screen is viewed. Typically the optimum contrast is observed only within a narrow viewing angle range centered about the normal incidence to the display and falls off rapidly as the viewing direction deviates from the display normal. In color displays, the leakage problem not only degrades the contrast but also causes color or hue shifts with an associated degradation of color reproduction.

Thus, one of the major factors measuring the quality of LCDs is the viewing angle characteristic, which describes a change in contrast ratio from different viewing angles. It is desirable to be able to see the same image from a wide variation in viewing angles and this ability has been a shortcoming with liquid crystal display devices. One way to improve the viewing angle characteristic is to employ a cover sheet having a viewing angle compensation layer (also referred to as a compensation layer, retarder layer, or phase difference layer), with proper optical properties, between the Dichroic PVA film and liquid crystal cell, such as disclosed in U.S. Pat. Nos. 5,583,679; 5,853,801; 5,619,352; 5,978,055; and 6,160,597. A compensation film according to U.S. Pat. Nos. 5,583,679 and 5,853,801 based on discotic liquid crystals which have negative birefringence, is widely used.

Viewing angle compensation layers for use in the cover sheets used in the present invention are optically anisotropic layers. The optically anisotropic, viewing angle compensation layers may comprise positively birefringent materials or negatively birefringent materials. The compensation layer may be optically uniaxial or optically biaxial. The compensation layer may have its optic axis tilted in the plane perpendicular to the layer. The tilt of the optic axis may be constant in the layer thickness direction or the tilt of the optic axis may vary in the layer thickness direction.

Optically anisotropic, viewing angle compensation layers may comprise the negatively birefringent, discotic liquid crystals described in U.S. Pat. Nos. 5,583,679 and 5,853,801; the positively birefringent nematic liquid crystals described in U.S. Pat. No. 6,160,597; the negatively birefringent amorphous polymers described in commonly assigned U.S. Patent Application Publication 2004/0021814A and U.S. patent application Ser. No. 10/745,109, filed Dec. 23, 2003. These latter two patent applications describe compensation layers comprising polymers that contain non-visible chromophore groups such as vinyl, carbonyl, amide, imide, ester, carbonate, sulfone, azo, and aromatic groups (i.e. benzene, naphthalate, biphenyl, bisphenol A) in the polymer backbone and that preferably have a glass transition temperature of greater than 180 degree C. Such polymers are particularly useful in the compensation layer of the present invention. Such polymers include polyesters, polycarbonates, polyimides, polyetherimides, and polythiophenes. Of these, particularly preferred polymers for use in the present invention include: (1) a poly(4,4′-hexafluoroisopropylidene-bisphenol)terephthalate-co-isophthalate; (2) a poly(4,4′-hexahydro-4,7-methanoindan-5-ylidene bisphenol)terephthalate; (3) a poly(4,4′-isopropylidene-2,2′6,6′-tetrachlorobisphenol)terephthalate-co-isophthalate; (4) a poly(4,4′-hexafluoroisopropylidene)-bisphenol-co-(2-norbornylidene)-bisphenol terephthalate; (5) a poly(4,4′-hexahydro-4,7-methanoindan-5-ylidene)-bisphenol-co-(4,4′-isopropylidene-2,2′,6,6′-tetrabromo)-bisphenol terephthalate; (6) a poly(4,4′-isopropylidene-bisphenol-co-4,4′-(2-norbornylidene)bisphenol)terephthalate-co-isophthalate; (7) a poly(4,4′-hexafluoroisopropylidene-bisphenol-co-4,4′-(2-norbornylidene)bisphenol)terephthalate-co-isophthalate; or (8) copolymers of any two or more of the foregoing. A compensation layer comprising these polymers typically has an out-of-plane retardation, Rₜₕ, that is more negative than −20 nm, preferably Rₜₕ is from −60 to −600 nm, and most preferably Rₜₕ is from −150 to −500 nm.

Another optional compensation layer suitable cover sheets used in the present invention includes an optically anisotropic layer comprising an exfoliated inorganic clay material in a polymeric binder as described in Japanese Patent Application 11095208A.

The auxiliary layers of the invention can be applied by any of a number of well known liquid coating techniques, such as dip coating, rod coating, blade coating, air knife coating, gravure coating, microgravure coating, reverse roll coating, slot coating, extrusion coating, slide coating, curtain coating, or by vacuum deposition techniques. In the case of liquid coating, the wet layer is generally dried by simple evaporation, which may be accelerated by known techniques such as convection heating. The auxiliary layer may be applied simultaneously with other layers such as subbing layers and the low birefringence protective polymer film. Several different auxiliary layers may be coated simultaneously using slide coating, for example, an antistatic layer may be coated simultaneously with a moisture barrier layer or a moisture barrier layer may be coated simultaneously with a viewing angle compensation layer. Known coating and drying methods are described in further detail in Research Disclosure 308119, Published December 1989, pages 1007 to 1008.

The cover sheets used in the invention are suitable for use with a wide variety of LCD display modes, for example, Twisted Nematic (TN), Super Twisted Nematic (STN), Optically Compensated Bend (OCB), In Plane Switching (IPS), or Vertically Aligned (VA) liquid crystal displays. These various liquid crystal display technologies have been reviewed in U.S. Pat. No. 5,619,352 (Koch et al.), U.S. Pat. No. 5,410,422 (Bos), and U.S. Pat. No. 4,701,028 (Clerc et al.).

FIG. 18 presents a cross-sectional illustration showing a liquid crystal cell 260 having polarizer plates 252 and 254 disposed on either side. Polarizer plate 254 is on the side of the LCD cell closest to the viewer. Each polarizer plate employs two cover sheets. For the purpose of illustration, polarizer plate 254 is shown with an uppermost cover sheet (this is the cover sheet closest to the viewer) comprising a layer promoting adhesion to PVA 261, tie layer 262, low birefringence protective polymer film 264, barrier layer 266, and antiglare layer 268. The lowermost cover sheet contained in polarizer plate 254 comprises a layer promoting adhesion to PVA 261, tie layer 262, low birefringence protective polymer film 264, barrier layer 266, and viewing angle compensation layer 272. On the opposite side of the LCD cell, polarizer plate 252 is shown with an uppermost cover sheet, which for the purpose of illustration, comprises a layer promoting adhesion to PVA 261, tie layer 262, low birefringence protective polymer film 264, barrier layer 266, and viewing angle compensation layer 272. Polarizer plate 252 also has a lowermost cover sheet comprising a layer promoting adhesion to PVA 261, tie layer 262, low birefringence protective polymer film 264, and barrier layer 266.

The present invention is illustrated in more detail by the following non-limiting examples.

### EXAMPLES

### Example 1

A 100 micrometer thick poly(ethylene terephthalate) (PET) carrier substrate having an antistatic backing layer (backside) is coated on its front surface with a layer promoting adhesion to PVA film comprising CELVOL 205 PVA (polyvinyl alcohol having a degree of hydrolysis of about 88-89%, available from Celanese Corp.) having a dry coating weight of about 750 mg/m², and NEOREZ R-600 (polyurethane dispersion from NeoResins Inc.) having a coating weight of about 250 mg/m². The dried layer is then overcoated with a triacetyl cellulose (TAC) formulation comprising three layers: a surface layer comprising CA-438-80S (triacetyl cellulose from Eastman Chemical) having a dry coating weight of about 2080 mg/m², diethyl phthalate having a dry coating weight of about 208 mg/m², and SURFLON S-8405-S50 (a fluorinated surfactant from Semi Chemical Co. Ltd) having a dry coating weight of about 210 mg/m²; a mid layer comprising CA-438-80S having a dry coating weight of about 18990 mg/m², Surflon® S-8405-S50 having a dry coating weight of about 295 mg/m², diethyl phthalate having a dry coating weight of about 1900 mg/m², TINUVIN® 8515 UV absorber (a mixture of 2-(2′-Hydroxy-3′-tert-butyl-5′-methylphenyl)-5-chloro benzotriazole and 2-(2′-Hydroxy-3′,5′-ditert-butylphenyl)-benzotriazole, available from Ciba Specialty Chemicals) having a dry coating weight of about 840 mg/m², and PARSOL 1789 UV absorber (4-(1,1-dimethylethyl)-4′-methoxydibenzoylmethane, available from Roche Vitamins Inc.) having a dry coating weight of about 8.4 mg/ft²; a lower layer as the tie layer comprising a mixture of 95:5 cellulose acetate trimellitate (Sigma-Aldrich) and trimethyl borate and having a dry coating weight of about 1000 mg/m². The TAC formulation was applied with a multi-slot slide hopper using a mixture of methylene chloride and methanol as the coating solvent. The cellulose acetate trimellitate has an acid number of 182.

The guarded cover sheet composite made above, 1330 mm in width, is wound onto a supply roll. The outer diameter of the supply roll after winding is 300 mm on a 152 mm core. In accordance with the present invention, the dried TAC coating is peeled off from the PET carrier substrate at the interface between the front side of the carrier substrate and the layer promoting adhesion of PVA film. The peeled film is then laminated to a PVA film having a thickness of about 25 micrometers using a glue solution comprising 61.5% water, 38.3% methanol, 0.13% boric acid, and 0.07% zinc chloride. The laminated film is dried in an oven at 60° C. for about 3 minutes.

In accordance with the present process, continuous production, including lamination, occurs during roll change. The machine line speed is maintained at 3 meters per minute. The unwind tension of the supply roll is held constant at 10 to 150 Newtons per meter width, controlled by its accumulator position. The PET winding roll has a core outer diameter of 152 mm. The PET winders are controlled by its accumulator position; its tension adjusted by accumulator air cylinder pressure. The PET winding tension is 300 to 400 Newtons per meter width at constant tension (alternatively taper tension may be used). A 125 mm diameter roller is used as the peeling station, where the PET carrier web touches the peeling roller. The unguarded cover sheet between the peeling station and the lamination nip is controlled to a tension of 100 to 500 Newtons per meter width. The lamination nip force is set to 100 to 500 Newtons per meter width. After peeled, the PET carrier web tension is 300 t0 400 Newtons per meter width.

### Example 2

Alternate guarded composite sheets can be used in the present invention. A 100 micrometer thick poly(ethylene terephthalate) (PET) carrier substrate having an antistatic backing layer (backside) is coated on its front surface with a layer promoting adhesion to PVA film comprising CELVOL 205 PVA (polyvinyl alcohol having a degree of hydrolysis of about 88-89%, available from Celanese Corp.) having a dry coating weight of about 750 mg/m², and NEOREZ R-600 (from NeoResins Inc.) having a coating weight of about 250 mg/m². The dried layer is then overcoated with a tie layer comprising poly(ethyl methacrylate-co-methacrylic acid) (acid number 130) having a dry coating weight of about 1000 mg/m². The tie layer is overcoated with a triacetyl cellulose (TAC) formulation comprising three layers: a surface layer comprising CA-438-80S (triacetyl cellulose from Eastman Chemical) having a dry coating weight of about 2080 mg/m², dihexyl cyclohexane dicarboxylate having a dry coating weight of about 208 mg/m², and SURFLON S-8405-S50 (a fluorinated surfactant from Semi Chemical Co. Ltd) having a dry coating weight of about 210 mg/m²; a mid layer comprising CA-438-80S having a dry coating weight of about 17370 mg/m², SURFLON S-8405-S50 having a dry coating weight of about 295 mg/m², dihexyl cyclohexane dicarboxylate having a dry coating weight of about 1930 mg/m², TINUVIN 8515 UV absorber having a dry coating weight of about 650 mg/m², and PARSOL 1789 UV absorber having a dry coating weight of about 65 mg/m²; a lower layer comprising a 47.5:47.5:5 mixture CARBOSET 525 (Noveon Inc.), poly(vinyl acetate-co-crotonic acid) (Sigma-Aldrich), and trimethyl borate having a dry coating weight of about 1000 mg/m². The TAC formulation was applied with a multi-slot slide hopper using a mixture of methylene chloride and methanol as the coating solvent.

This cover sheet is peeled and laminated as follows in which continuous production, including lamination, occurs during roll change and the machine line speed is maintained at 3 meters per minute. The unwind tension of the supply roll is held constant at 10 to 150 Newtons per meter width, controlled by its accumulator position. The PET winding roll has a core outer diameter of 152 mm. The PET winders are controlled by its accumulator position; its tension adjusted by accumulator air cylinder pressure. The PET winding tension is 300 to 400 Newtons per meter width at constant tension (alternatively taper tension may be used). A 125 mm diameter roller is used as the peeling station, where the PET carrier web touches the peeling roller. The unguarded cover sheet between the peeling station and the lamination nip is controlled to a tension of 100 to 500 Newtons per meter width. The lamination nip force is set to 100 to 500 Newtons per meter width. After peeled, the PET carrier web tension is 300 t0 400 Newtons per meter width.

The invention has been described in detail with particular reference to certain preferred embodiments thereof, but it will be understood that variations and modifications can be effected within the spirit and scope of the invention.

### PARTS LIST

10 coating and drying system
12 moving substrate
14 dryer
16 coating apparatus
18 unwinding station
20 back-up roller
22 coated substrate
24 guarded cover sheet composite
26 wind-up station
28 coating supply vessel
30 coating supply vessel
32 coating supply vessel
34 coating supply vessel
36 pumps
38 pumps
40 pumps
42 pumps
44 conduits
46 conduits
48 conduits
50 conduits
52 discharge device
54 polar charge assist device
56 opposing roller
58 opposing roller
60 preformed strippable protection layer
62 unwinding station
64 wind-up station
66 drying section

### Parts List—Continued

68 drying section
70 drying section
72 drying section
74 drying section
76 drying section
78 drying section
80 drying section
82 drying section
92 front section
94 second section
96 third section
98 fourth section
100 back plate
102 inlet
104 metering slot
106 pump
108 lowermost layer
110 inlet
112 metering slot
114 pump
116 layer
118 inlet
120 metering slot
122 pump
124 layer
126 inlet
128 metering slot
130 pump
132 layer

### Parts List—Continued

134 inclined slide surface
136 coating lip
138 2^{nd} inclined slide surface
140 3^{rd} inclined slide surface
142 4^{th} inclined slide surface
144 back land surface
146 coating bead
151 guarded cover sheet composite (composite sheet)
153 guarded cover sheet composite (composite sheet)
159 guarded cover sheet composite
162 lowermost layer
164 intermediate layer
166 intermediate layer
168 uppermost layer
170a,b carrier substrate
171 cover sheet
173 cover sheet
174 lowermost layer
176 intermediate layer
178 intermediate layer
179 cover sheet
180 uppermost layer
182 carrier substrate
184 release layer
186 lowermost layer
188 intermediate layer
189 cover sheet
190 uppermost layer
200a,b supply roll

### Parts List—Continued

201a, b fresh supply roll
202 web (PVA-dichroic film)
203a, b spindle
205 downstream lamination pinch rollers
206 lamination pinch rollers
207 downstream lamination pinch roller
208 lamination pinch rollers
209 downstream bowed roller
210a, b carrier winder
211 conveyance roller
212a, b peeling roller
213a, b empty core
214a, b bowed (bending) roller
215a, b load cell roller
222 fresh web
223a, b winding spindle
216a, b double-sided splicing means
217a, b accumulator rollers
218a, b accumulator
219a, b clamp
220a, b drive roller
221a, b frames
222 fresh web
224 fresh carrier sheet
226 fresh adhesive layer
228 fresh cover sheet
232 expiring web
234 pre-peeled cover sheet portion
236 pre-peeled carrier web portion

### Parts List—Continued

238a,b single-sided tape
240a,b backing support layer
242a,b glue-containing layer
244 expiring cover sheet
246 expiring carrier sheet
247 expiring adhesive layer
250 polarizer plate web/sheet
252 rear polarizer plate in display
254 front polarizer plate in display
256 stationary knife
258 knife edge
260 LCD cell
261 layer promoting adhesion to PVA
262 tie layer
264 low birefringence protective polymer film
266 barrier layer
268 antiglare layer
272 viewing-angle compensation layer
274a,b double-sided tape
276a,b first feedback signal
278a,b second feedback signal
280 roller
281 roller
282 supplemental clamp
284 post-lamination accumulator
286 feedback signal to carrier winder
290 first control block
292 line speed reference
294 second control block

### Parts List—Continued

297 master drive
298 reference tension
300 tension error
302 tension loop software
304 speed trim
305a, b, c integrator
306a, b speed loop software
307a, b speed error
308a, b current loop
310a, b motor
312a, b gear box
314 feedback signal

1. A method of forming a polarizer plate comprising providing at least one guarded cover sheet composite comprising a carrier substrate and a cover sheet, the cover sheet comprising a layer promoting adhesion to polyvinyl alcohol and a low birefringence polymer film, providing a polyvinyl alcohol-containing polarizing film, and bringing the cover sheet into contact with the polarizing film such that the layer promoting adhesion to polyvinyl alcohol in the cover sheet is in contact with the polarizing film, thereby producing a polarizer plate composite sheet comprising a cover sheet and a polarizing film adhesively joined by the layer promoting adhesion to polyvinyl alcohol, wherein the carrier substrate is peeled from the cover sheet prior to bringing the cover sheet into contact with the polarizing film such that the layer promoting adhesion to polyvinyl alcohol in the cover sheet is contacted with the polarizing film, and wherein the method further comprises controlling tension of at least the cover sheet following peeling of the carrier substrate therefrom, wherein the carrier substrate comprises a polymeric film having a thickness of 20 to 200 micrometers.

2. The method of claim 1 wherein controlling the tension of the cover sheet comprises sensing a parameter associated with the cover sheet after peeling, which parameter bears a direct or indirect relation to the tension of the cover sheet, and comparing the sensed parameter to a set point.

3. The method of claim 2 wherein the parameter is the tension of the cover sheet or is a dimensional or positional characteristic of the cover sheet that intrinsically is related to tension of the cover sheet.

4. The method of claim 2 wherein the comparison is used to generate a signal for controlling a means for conveying the guarded cover sheet composite prior to the peeling.

5. The method of claim 4 wherein the means for conveying is a drive roller located before a peeling station for peeling the carrier substrate from the cover sheet and after a supply roll for the guarded cover sheet composite.

6. The method of claim 4 wherein the means for conveying is an unwinder for the guarded cover sheet composite that supplies the guarded cover sheet composite to a peeling station for peeling the carrier substrate from the cover sheet.

7. The method of claim 4 wherein speed of the means for conveying is increased when the sensed parameter indicates that either the tension of the cover sheet is too high or an amount of the guarded cover sheet composite in the vicinity of a means for sensing the parameter needs to be increased.

8. The method of claim 2 wherein the parameter is sensed by a sensing means that measures a distance related to a displacement of the cover sheet in a vicinity of the sensing means.

9. The method of claim 2 wherein the parameter is sensed by sensing means that measures the tension of the cover sheet.

10. The method of claim 2 wherein the parameter is sensed by a float roller or load cell.

11. The method of claim 1 wherein the tension of the cover sheet is maintained within a set range during steady state operation of the method.

12. The method of claim 2 wherein the set point is between 30 Newtons per meter and 1000 Newtons per meter.

13. The method of claim 2 wherein variation of the tension of the cover sheet that is sensed during steady state operation is maintained within 15 percent of the set point.

14. The method of claim 1 wherein the cover sheet is brought into contact with the polarizing film at a lamination station comprising nip rollers, the speed of nip rollers being maintained by a master drive.

15. The method of claim 1 wherein the layer promoting adhesion to polyvinyl alcohol is adjacent to the carrier substrate.

16. The method of claim 1 wherein the carrier substrate comprises polyester.

17. The method of claim 1 wherein the low birefringence polymer protective film comprises cellulose ester.

18. The method of claim 1 wherein the cover sheet comprises at least one functional/auxiliary layer.

19. The method of claim 18 wherein the functional layer is a moisture barrier layer, antistatic layer, compensation layer, hard coat, antiglare, or anti-reflection layer.

20. The method of claim 19 wherein the hard coat, antiglare, or anti-reflection layers are on the side of the low birefringence polymer film opposite to the layer promoting adhesion to polyvinyl alcohol films.

21. The method of claim 1 wherein the cover sheet is peeled at a peeling station by means of a single roller, a contacting nip comprised of two rollers, a knife edge, or peeling rod.

22. The method of claim 21 further comprising conveying the cover sheet, after the peeling station and before a laminating station, through means for spreading a web.

23. The method of claim 22 wherein the means for spreading a web comprises a bowed or bending roller, a concave roller, or a flex roller.

24. The method of claim 1 wherein the cover sheet has a thickness less than 40 μm.

25. The method of claim 1 wherein the method further comprises drying the polarizer plate composite sheet by allowing moisture to be removed from the polarizer plate composite sheet without application of heat.

26. The method of claim 1 wherein glue is applied to the cover sheet or polarizing film prior to contact with a polarizing film.

27. The method of claim 1 wherein glue is applied to the cover sheet or polarizing film by spraying, dripping, roll coating, hopper coating, or knife coating.

28. The method of claim 26 wherein the glue is applied to the cover sheet after it is conveyed past means for spreading a web.

29. The method of claim 1 wherein said guarded cover sheet composite is heated prior to being peeled.

30. The method of claim 1 wherein electrostatic charge is removed from the cover sheet after being peeled.

31. The method of claim 1 wherein electrostatic charge is removed from the guarded cover sheet composite in proximity to an unwinder for the guarded cover sheet composite.

32. The method of claim 1 wherein the polarizer plate composite, after drying, is wound on a winder.

33. The method of claim 1, further comprising after the carrier substrate is peeled from the cover sheet, winding the carrier sheet onto a winder.

34. The method of claim 1 further comprising, after the carrier substrate is peeled from the cover sheet, disposing of the carrier web, for recycling, to a waste chopper.

35. The method of claim 1 wherein the layer promoting adhesion to polyvinyl alcohol comprises a hydrophilic polymer.

36. The method of claim 35 wherein the hydrophilic polymer is polyvinyl alcohol.

37. The method of claim 35 wherein the layer promoting adhesion to polyvinyl alcohol further comprises a crosslinking compound.

38. The method of claim 1 wherein the low birefringence polymer film comprises a polycarbonate or a cyclic polyolefin.

39. A method of forming a polarizing plate comprising in order the following steps
(a) supplying a first and a second web from a first and a second unwinder, respectively, each of the first and the second web comprising a guarded cover sheet having a carrier substrate and a protective cover sheet, the protective cover sheet comprising a low birefringence polymer protective film and a layer promoting adhesion to polyvinyl alcohol;
(b) optionally conveying each web through a drive roller;
(c) for each web, removing the carrier substrate from the protective cover sheet at a peeling station to each produce (i) an unguarded web comprising the protective cover sheet, and (ii) a carrier web comprising the carrier substrate;
(d) conveying each unguarded web over means for controlling its tension having feedback control to the drive roller;
(e) optionally conveying each unguarded web over a means for spreading the web;
(f) bringing each unguarded web, either simultaneously or sequentially, into contact with a polarizing web comprising a dichroic PVA film such that each layer promoting adhesion to polyvinyl alcohol, in each of the unguarded webs, are contacted with the dichroic PVA film, wherein pressure is applied as the dichroic PVA film and cover sheets are brought into contact, thereby forming a polarizer plate web; and
(g) drying the polarizer plate web.

40. A method of forming a polarizing plate comprising, in order, the following steps
(a) supplying a web from an unwinder, said web comprising a guarded cover sheet having a carrier substrate and a protective cover sheet, the protective cover sheet comprising a low birefringence polymer protective film and a layer promoting adhesion to polyvinyl alcohol;
(b) optionally conveying the web through a drive roller;
(c) removing the carrier substrate from the protective cover sheet at a peeling station to produce (i) an unguarded web comprising the protective cover sheet and (ii) a carrier web comprising the carrier substrate;
(d) conveying the unguarded web over means for controlling tension having feedback control to a drive for the drive roller;
(e) optionally conveying the unguarded web over a means for spreading the web;
(f) bringing the unguarded web into contact with a polarizing web comprising a dichroic PVA film such that the layer promoting adhesion to polyvinyl alcohol, in the unguarded web, is contacted with the dichroic PVA film, wherein pressure is applied as the dichroic PVA film and the cover sheet are brought into contact, thereby forming a polarizing plate composite sheet; and
(g) optionally, either simultaneously or sequentially with step (f), contacting the polarizing web with a second unguarded web on the opposite side of the polarizing web to form a polarizer plate web;
(h) drying the polarizer plate web.
